(19) United States
(12) Patent Application Publication
(10) Pub. No.: US 2024/0152101 A1
(43) Pub. Date: May 9, 2024

(54) CONTROL DEVICE, CONTROL METHOD, AND SYSTEM

(71) Applicant: Asahi Kasei Microdevices Corporation, Tokyo (JP)

(72) Inventor: Shiro TAGA, Tokyo (JP)

(21) Appl. No.: 18/495,762

(22) Filed: Oct. 27, 2023

(30) Foreign Application Priority Data
Oct. 31, 2022 (JP) 2022-174139
Sep. 8, 2023 (JP) 2023-145702

(51) Int. Cl. G05B 13/02; H02J 3/00; H02M 3/00

(52) U.S. Cl. CPC G05B 13/024; H02J 3/00; H02M 3/01

(57) ABSTRACT

A control device that controls a load amount of a load device that receives supply of power output from a DC power supply is provided. The control device includes a setting unit that compares a voltage ratio in which a denominator is set to a first input voltage value indicating a magnitude of an input voltage applied when the load device is set to a first load amount, and a numerator is set to a second input voltage value based on a magnitude of an input voltage applied to the load device when it is set to a second load amount obtained by multiplying the first load amount by a predetermined first coefficient, and a determination value in accordance with the first coefficient, and executes a load amount setting process in which the load device is set to a new first load amount, until a predetermined condition is satisfied.

The contents of the following patent application(s) are incorporated herein by reference:
NO. 2022-174139 filed in JP on Oct. 31, 2022
NO. 2023-145702 filed in JP on Sep. 8, 2023

### BACKGROUND

### 1. Technical Field

The present invention relates to a control device, a control method, and a system.

### 2. Related Art

Patent Document 1 discloses an energy harvesting system that uses a power management IC, and Patent Documents 2 and 3 disclose an energy harvesting terminal or an energy harvesting system that uses a DC-DC converter.

### PRIOR ART DOCUMENT

### Patent Document

Patent Document 1: U.S. Pat. No. 11,157,032
Patent Document 2: Japanese Patent No. 6152919
Patent Document 3: Japanese Patent No. 5921447

### BRIEF DESCRIPTION OF THE DRAWINGS

FIG. 1A is a block diagram showing an example of a configuration of a system 100.

FIG. 1B is a block diagram showing another example of the configuration of the system

FIG. 2 is a flowchart showing an example of an operation of the system 100.

FIG. 3 is a circuit diagram showing examples of configurations of a power supply 10a and a load device 110b.

FIG. 4 is a circuit diagram showing an example of a configuration of a load device 110c.

FIG. 5 is a circuit diagram showing an example of a configuration of a load device 110d.

FIG. 6 is a graph showing changes in a voltage ratio Vo(Rk/α)/Vo(Rk) and a power ratio Pi/Popt when a resistance Rk(Ω) of the load device 110b changes.

FIG. 7 is a circuit diagram showing examples of configurations of the power supply 10a and a load device 110e.

FIG. 8 is a graph showing changes in a voltage ratio Vo(α×Ik)/Vo(Ik) and the power ratio Pi/Popt when a current Ik(A) of the load device 110e changes.

FIG. 9 is a circuit diagram showing examples of configurations of the power supply 10a and a load device 110f.

FIG. 10 is a graph showing changes in a voltage ratio Vo(α×Pk)/Vo(Pk) and the power ratio Pi/Popt when power Pk(W) of the load device 110f changes.

FIG. 11 is a circuit diagram showing examples of configurations of a power supply 10b and the load device 110b when a solar cell is used as the power supply 10b.

FIG. 12 is a graph showing examples of an output current I and power Po which is consumed by the load, with respect to an output voltage Vo, when an arbitrary load is connected to the power supply 10b.

FIG. 13 is a graph showing changes in the voltage ratio Vo(Rk/α)/Vo(Rk) and the power ratio Pi/Popt when the load device 110b is connected to the power supply 10b.

FIG. 14 is a block diagram showing yet another example of the configuration of the system

FIG. 15 is a flowchart showing an example of the operation of the system 100 according to FIG. 14.

FIG. 16A is a block diagram showing an example of a configuration of a system 300.

FIG. 16B is a block diagram showing another example of the configuration of the system 300.

FIG. 17 is a block diagram showing an example of a configuration of a system 400.

FIG. 18A is a flowchart showing an example of a first half of an operation sequence of the system 400.

FIG. 18B is a flowchart showing an example of a second half of the operation sequence of the system 400.

FIG. 19 is a circuit diagram showing examples of configurations of a sampling device 120 and a scaling device 130.

FIG. 20 is a timing diagram showing examples of operations of the sampling device 120 and the scaling device 130.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solving means of the invention.

A device is known for extracting power from various power supplies, driving a load with an output voltage or an output current which are desired, and charging a capacitor and a storage battery including a lithium ion battery (LIB). As such a device, there is a DC-DC converter including a step-up type, a step-down type, or the like, and a power management IC (PMIC: Power Management Integrated Circuit).

Among the power supplies that are used for such a purpose, there is solar power generation, vibration power generation, electromagnetic wave power supply, or the like in which an output resistance of a power supply is not small. When a current is drawn beyond a load amount at which maximum power can be obtained from the power supply (hereinafter referred to as a “maximum power point”) in which the output resistance is large, the output voltage may drop steeply such that it is not possible to extract the power with a high efficiency.

Therefore, the DC-DC converter and the PMIC that have a Maximum Power Point Tracking (MPPT) function as a function of extracting the power with a high efficiency, are known. One of methods for realizing the MPPT is a Hill Climbing Method. In the hill climbing method, the current and the power flowing in from the power supply are measured, and when the current is increased by a control of the current and the output power is increased, the current is controlled to be further increased; and conversely, when the output power is decreased despite the increasing of the current, the current is controlled to be decreased. The hill climbing method is a control for the maximum power point (MPP) to be always reached in this way.

In the hill climbing method, the power is directly observed, and thus it is possible to realize the MPPT with a high precision; however, a complicated electric circuit is required to measure the power and calculate the MPP, and a lot of power is consumed. Accordingly, the hill climbing method is applied to a power conditioner of photovoltaic power generation or the like in which the output power is relatively large.

On the other hand, as a method for realizing the MPPT in an energy harvesting field such as a small scale solar power generation, thermal power generation, vibration power generation, and electromagnetic wave power supply in which the output power is small, there is a method for measuring an open-circuit voltage (Vs) in a no-load state. In this method, an output of the converter is controlled such that the output voltage of the power supply is 50% or 80% of the measured open-circuit voltage. A lot of ICs in which this method is used are commercially available.

However, such an IC may have the following problems. First, for some of the vibration power generation, the electromagnetic wave power supply, and the like, there is a risk that a voltage rises to damage an element when the no-load state is set during the power generation.

Second, in a case where a microwave is rectified to generate a DC power, a rectifier configured by a semiconductor element such as a transistor or a diode is used. These semiconductor elements have internal resistances, and thus when the current flows through the element, the semiconductor element consumes the power proportional to a square of the current. In such a technical field, in order to decrease such power consumption, a high frequency circuit is designed to have high impedance, and an antenna and a matching circuit are designed to be operated by a high output voltage and a low output current. However, it is not possible to apply a voltage higher than or equal to a breakdown voltage to the semiconductor element, and thus in the MPPT method that measures the open-circuit voltage, only an operation at 50% or lower of the breakdown voltage is possible, and it is not possible to use a region with a highest efficiency.

Therefore, Patent Document 1 presents an energy harvesting system that uses an impedance element configured to function as a dummy load of an energy source, instead of disabling the converter to measure the open-circuit voltage. This energy harvesting system measures an optimal input voltage value for realizing the MPP by connecting the impedance element; enables the converter after disconnecting the impedance; and controls the converter such that the measured optimal input voltage value and an input voltage are equal to each other.

However, the optimal impedance (or the power supply impedance) for realizing the MPP is greatly changed by an environment in which the power supply is placed, such as a radio wave intensity and a temperature. In the energy harvesting system described above, the impedance which is connected cannot track a change in the power supply impedance. Accordingly, the energy harvesting system described above cannot always supply the optimal input voltage value for realizing the MPP.

A system will be described below, that realizes an estimation of the maximum power point without measuring the open-circuit voltage and that realizes the maximum power point tracking which can also track a change in the impedance according to a change in an external environment. In addition, it is possible to use the system to be described as a system that increases the power which is output from the power supply to a load device to achieve a target power value of power other than the maximum power point. Further, the system to be described has a simple configuration, and is applicable to energy harvesting. In addition, a description will be made for a similar control method to be also applicable to the DC-DC converter.

In the present specification, the “connection” refers to being electrically connected, and includes being directly connected and being indirectly connected via a circuit element. In addition, in the present specification, a case where a logic level of a signal is a high level, is referred to as an “H” level; and a case where the logic level of the signal is a low level, is referred to as an “L” level.

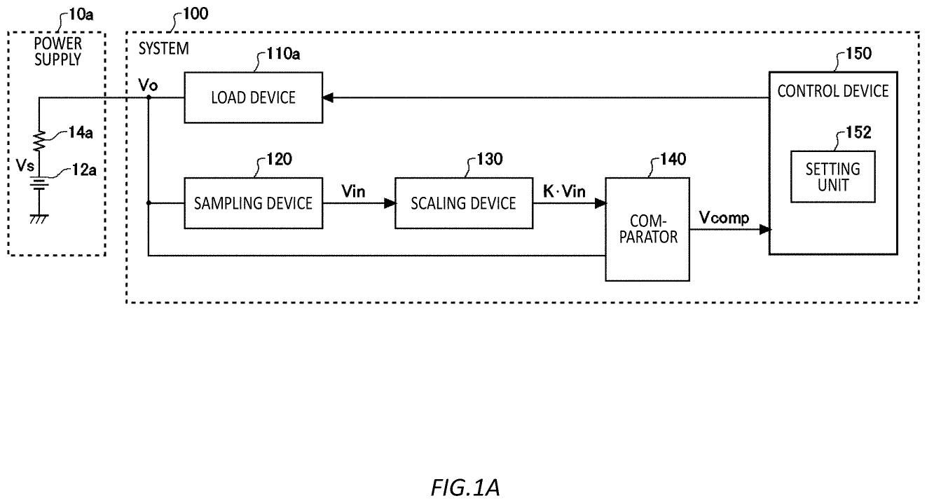

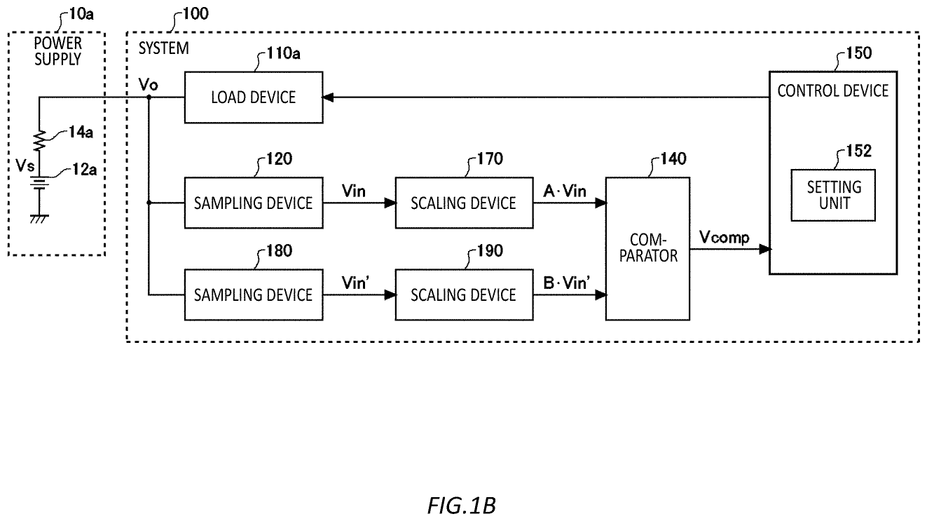

FIG. 1A is a block diagram showing an example of a configuration of a system 100. The system 100 is a system that controls the load of a load device 110a to be described below in the system 100 and adjusts the power based on a voltage Vo which is applied to the load device 110a from a power supply 10a.

The power supply 10a supplies DC voltage to the system 100. The power supply 10a includes a voltage source 12a and a resistor 14a.

The voltage source 12a is a voltage source that supplies a DC voltage Vs. For example, the voltage source 12a is a battery. As another example, it may be a rectenna that receives an electromagnetic wave by the antenna and performs an AC to DC conversion by a rectifier circuit, and the DC output voltage Vs of the rectenna is changed according to the intensity of the electromagnetic wave which is received.

The resistor 14a is an internal resistance of the power supply 10a. The resistor 14a has a resistance value Rs. When the resistance value Rs of the resistor 14a is zero, the voltage Vs is supplied from the power supply 10a, and in this sense, the voltage Vs is referred to as the open-circuit voltage. As an example, when the voltage source 12a is the battery, the resistor 14a is an internal resistance of the battery. As another example, when the voltage source 12a is the rectenna, the resistor 14a is an output resistance of the rectenna.

An internal configuration of the system 100 will be described. The system 100 comprises the load device 110a, a sampling device 120, a scaling device 130, a comparator 140, and a control device 150.

The load device 110a is a variable load in which a load amount varies according to the control of the control device 150. The load device 110a is connected to the power supply 10a, and consumes energy (power) supplied from the power supply 10a.

Here, the “load amount” of the load device 110a is an electrical index for changing a magnitude of the power which is consumed by the load device. For example, the load amount is an input current value indicating the magnitude of the current which is input to the load device 110a; a resistance value indicating the magnitude of the resistance that consumes the power at the load device 110a; an input voltage value indicating the magnitude of the voltage which is applied to the load device 110a; or a power value indicating the magnitude of power which is consumed by the load device 110a. The fact that the load amount is large indicates that the power which is consumed by the load device 110a is large, and the fact that the load amount is small indicates that the power which is consumed by the load device 110a is small.

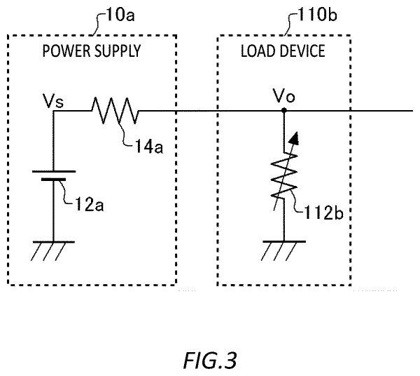

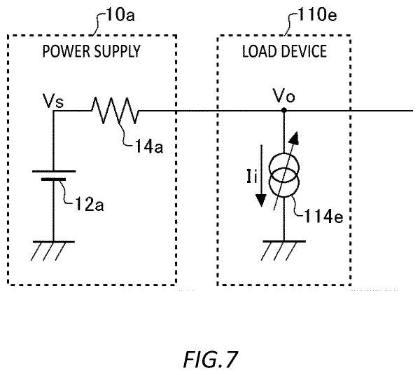

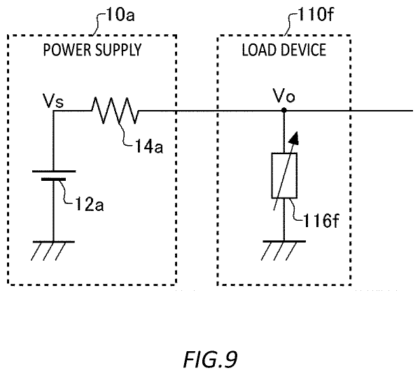

The load device 110a only needs to be able to vary the power which is consumed by the load device, and the load device 110a may be a variable resistor, a variable current source, or a variable power load. A specific configuration example of the load device 110a will be described below with reference to FIG. 3 to FIG. 5, FIG. 7, FIG. 9, and the like.

In the present specification, the load amount of the load device 110a being larger than the load amount indicating a maximum amount of power may be referred to as an “overload”. Conversely, the load amount of the load device 110a being smaller than the load amount indicating the maximum amount of power may be referred to as a “light load”.

The sampling device 120 samples the voltage Vo when the load amount of the load device 110a is set to a predetermined value. Specifically, the sampling device 120 samples the voltage Vo when the load amount of the load device 110a has a value L(n) to be described below, and supplies the voltage Vo to the scaling device 130 as a voltage Vin. The sampling device 120 is connected to the power supply 10a in parallel with the load device 110a.

The scaling device 130 outputs voltage K×Vin obtained by scaling the voltage Vin which is supplied from the load device 110a by a predetermined coefficient K. The coefficient K is a positive real number which is set in advance. The scaling device 130 is connected to the sampling device 120.

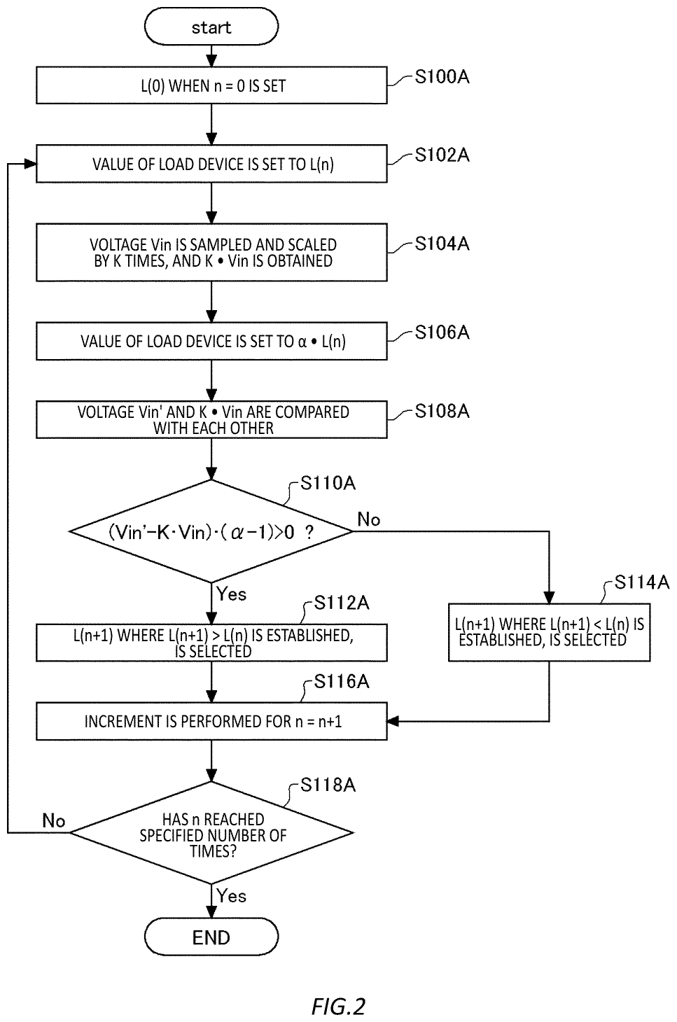

The comparator 140 compares the voltage K×Vin which is supplied from the scaling device 130, and a voltage Vin′ when the load device 110a has a load α×L(n). The comparator 140 outputs a signal Vcomp of a logic level which differs depending on a comparison result between the voltage K×Vin and the voltage Vin′. Here, the coefficient α is a positive real number that is set by the control device 150 and that satisfies α≠1, as will be described below with reference to FIG. 2.

The comparator 140 has at least two input ends. One end of the input ends of the comparator 140 is connected to the scaling device 130, and the other end of the input ends of the comparator 140 is connected to the power supply 10a in parallel with the load device 110a.

The control device 150 changes the load amount of the load device 110a according to the logic level of the signal Vcomp, and controls the load amount of the load device 110a to increase the power to be output from the power supply 10a to the load device 110a. Alternatively, the control device 150 may control the load amount of the load device 110a such that the power to be output from the power supply 10a to the load device 110a approaches the maximum. The control device 150 is connected to the comparator 140. The control device 150 also includes a setting unit 152.

When the load device 110a has the load amount L(n), the setting unit 152 sets a new load amount L(n+1), based on the value of the coefficient α and the logic level of the signal Vcomp. For example, when (Vin′−K×Vin)×(α−1)>0, the setting unit 152 sets the load amount of the load device 110a to the load amount L(n+1) which is larger than the load amount L(n). On the other hand, when (Vin′−K×Vin)×(α−1)<0, the setting unit 152 may set the load amount of the load device 110a to the load amount L(n+1) which is smaller than the load amount L(n).

Here, it is desirable that a rate of the change from the load amount L(n) to the next load amount L(n+1) is sufficiently small to enhance a tracking performance of the MPPT. The rate of the change from L(n) to α×L(n) may be larger than the rate of the change from the load amount L(n) to the next load amount L(n+1), to facilitate an operation of the comparator 140.

The control device 150 increments a value of n, and repeats processing of changing the load amount L(n) of the load device 110a until the value of n reaches a predetermined number. In this manner, the voltage Vo which is applied to the load L(n) and the current which flows through the load are varied, and the power which is extracted from the node to which the voltage Vo is applied approaches the maximum value. Below, the processing by which the system 100 of FIG. 1A sets the load amount of the load device 110a will be described in detail with reference to the flowchart of FIG. 2.

Here, the voltage Vo which is applied from the power supply 10a to the load device 110a corresponds to the “input voltage”. In addition, the load amount L(n) of the load device 110a corresponds to a “first load amount”, and the load amount α×L(n) corresponds to a “second load amount”. Further, the load amount L(n+1) of the load device 110a corresponds to a “new first load amount”.

Further, when the load device 110a has the load amount L(n), the value Vin indicated by the voltage Vo which is applied to the load device 110a, corresponds to a “first input voltage value”. In addition, when the load device 110a has the load amount α×L(n), the value Vin′ indicated by the voltage Vo which is applied to the load device 110a, corresponds to a “second input voltage value”. Here, the coefficient α is an example of a “first coefficient”, and the coefficient K is an example of a “second coefficient”.

FIG. 2 is a flowchart showing an example of an operation of the system 100. By the operation of the system 100, a control method is implemented to control the load amount of the load device 110a that receives the supply of the power which is output from the power supply 10a, so as to achieve the maximum power point. One sequence may be set from a START to an END in the flowchart, and the sequence may be performed only once, or may be performed multiple times in succession. The control method represented by the sequence in the figure includes steps S100A to S118A.

First, the control device 150 sets a load L(0) when n=0 for the load amount L(n) of the load device 110a (S100A). Next, the control device 150 sets the load amount of the load device 110a to the load amount L(n) (S102A). Here, n is an integer equal to or larger than zero. For the number of times of executions of the sequence, when the sequence is executed for the first time, the control device 150 may set the load amount of the load device 110a to L(0). In the second and subsequent sequences, the control device 150 uses a last value of a previous sequence, as the load L(n).

Next, the sampling device 120 samples the voltage Vo when the load device 110a has the load amount L(n), and supplies the voltage Vo to the scaling device 130 as the voltage Vin. Further, the scaling device 130 supplies the voltage K×Vin obtained by scaling the voltage Vin by the coefficient K, to one end of the input ends of the comparator 140 (S104A).

Further, the control device 150 sets the load amount of the load device 110a to the load α×L(n) (S106A). The voltage Vo when the load amount of the load device 110a is α×L(n) is set as the voltage Vin′. In this case, the load amount of the load device 110a is no longer L(n), and thus the sampling device 120 may stop the sampling operation.

Next, the comparator 140 compares the voltage K×Vin and the voltage Vin′, and outputs the signal Vcomp of the logic level which differs depending on the magnitudes of the voltage K×Vin and the voltage Vin′ (S108A). For example, the comparator 140 outputs the signal Vcomp of the “H” level when (K×Vin−Vin′)>0. On the other hand, the comparator 140 outputs the signal Vcomp of the “L” level when (K×Vin−Vin′)<0. Here, the logic level of the signal Vcomp which is output from the comparator 140 is merely an example, and may be the inverse logic level of the present embodiment.

After S104A and S106A are performed, S108A may be performed, and order in which S104A and S106A are performed is not limited to the order described above. Accordingly, after S106A is performed, S102A and S104A may be performed, and then S108A may be performed.

Next, the setting unit 152 determines whether an inequality (Vin′−K×Vin)×(α−1)>0 is satisfied (S110A). Specifically, the setting unit 152 performs the determination based on the value of α and the logic level of the signal Vcomp. For example, when α>1, the setting unit 152 determines that the inequality (Vin′−K×Vin)×(α−1)>0 is satisfied, according to the signal Vcomp of the “H” level. On the other hand, it is determined that the inequality (Vin′−K×Vin)×(α−1)>0 is not satisfied, according to the signal Vcomp of the “L” level.

Alternatively, when 0<α<1, the setting unit 152 determines that the inequality (Vin′−K×Vin)×(α−1)>0 is satisfied, according to the signal Vcomp of the “L” level. On the other hand, the setting unit 152 determines that the inequality (Vin′−K×Vin)×(α−1)>0 is not satisfied, according to the signal Vcomp of the “H” level.

If it is determined that the inequality (Vin′−K×Vin)×(α−1)>0 is satisfied, the setting unit 152 sets the load amount of the load device 110a to the load amount L(n+1) which is larger than L(n) (that is, L(n+1)>L(n) is satisfied) (S112A). After this, the processing proceeds to S116A.

Accordingly, when α>1 (that is, α×L(n)>L(n)) and the voltage value Vin′ is larger than the voltage value K×Vin, the load amount of the load device 110a is set to the load amount L(n+1) which is larger than L(n). On the other hand, when 0<α<1 (that is, α×L(n)<L(n)) and the voltage value Vin′ is smaller than the voltage value K×Vin, the load amount of the load device 110a is set to the load amount L(n+1) which is larger than L(n).

If it is determined that the inequality (Vin′−K×Vin)×(α−1)>0 is not satisfied, the setting unit 152 sets the load amount of the load device 110a to the load amount L(n+1) which is smaller than L(n) (that is, L(n+1)<L(n) is satisfied) (S114A). After this, the processing proceeds to S116A.

Accordingly, when α>1 (that is, α×L(n)>L(n)) and the voltage value Vin′ is smaller than the voltage value K×Vin, the load amount of the load device 110a is set to the load amount L(n+1) which is smaller than L(n). On the other hand, when 0<α<1 (that is, α×L(n)<L(n)) and the voltage value Vin′ is larger than the voltage value K×Vin, the load amount of the load device 110a is set to the load amount L(n+1) which is smaller than L(n).

The setting unit 152 increments the value of n to n=n+1 (S116A). Next, the setting unit 152 compares n with a predetermined threshold value and determines whether the value of n is larger than or equal to the predetermined threshold value (a specified number of times) (S118A).

If n reaches the specified number of times, the setting unit 152 ends the processing of the load amount L(n) (S118A). If n does not reach the specified number of times, the setting unit 152 returns the processing to S102A, and the system 100 performs the processing from S102A to S118A again.

As described above, the processing from S102A to S118A is repeated until n reaches the specified number of times. In a case where the processing from the START to the END until n reaches the specified number of times is set as one sequence, the load amount L(n) of the load device 110a is increased or decreased through this sequence, and approaches L(n) which realizes the maximum amount of power. A description will be made for this approaching value to be L(n) of the maximum power point, with reference to FIG. 3 to FIG. 10 regarding an example in which the load of the load device 110a is the variable resistor, an example in which the load of the load device 110a is the variable current source, and an example in which the load of the load device 110a is the variable power load.

Here, in a case where the specified number of times is large, the setting unit 152 can set the load amount L(n) which is the maximum power point by one sequence. On the other hand, when the specified number of times is small, by the system 100 repeating this sequence a predetermined number of times, the load amount L(n) is changed to track the load amount which is the maximum power point. A tracking speed is changed by a time interval between the sequences, and the specified number of times, and thus the time interval and the specified number of times may be set according to the changes in the environment and the condition.

In a case where this sequence has been repeated a predetermined number of times, the setting unit 152 assumes that a predetermined condition for performing a load amount setting process of the load device 110a is satisfied, and ends the load amount setting process. It should be noted that as a predetermined condition for the setting unit 152 to stop the sequence, another condition other than the number of times (for example, determination of a repeat time or the like) may be used.

In the figure, the coefficient K is used as an example of the “second coefficient”; however, the coefficient 1/K may be used as an example of a “third coefficient”. The second coefficient or the third coefficient may be a value in accordance with the first coefficient. Further, for the voltage Vo to be sampled, the voltage Vin when the load amount of the load device 110a is set to α×L(n) may be sampled (a modification example of S104A). In this case, as the subsequent step, the setting unit 152 sets the load amount of the load device 110a to L(n) (the modification example of S106A), and the comparator 140 compares the voltage (1/K)×Vin′ and the voltage Vin (the modification example of S108A).

Next, the setting unit 152 determines whether the inequality (1/K×Vin′−Vin)×(α−1)>0 is satisfied (the modification example of S110A); sets the load amount of the load device 110a to L(n+1) which is larger than L(n) if (1/K×Vin′−Vin)×(α−1)>0 (modification example of S112A); and sets the load amount of the load device 110a to L(n+1) which is smaller than L(n) if (1/K×Vin′−Vin)×(α−1)>0 is not satisfied (the modification example of S114A). In relation to S104A to S114A, in a case where such a modification example is used, as well, a similar control method is realized.

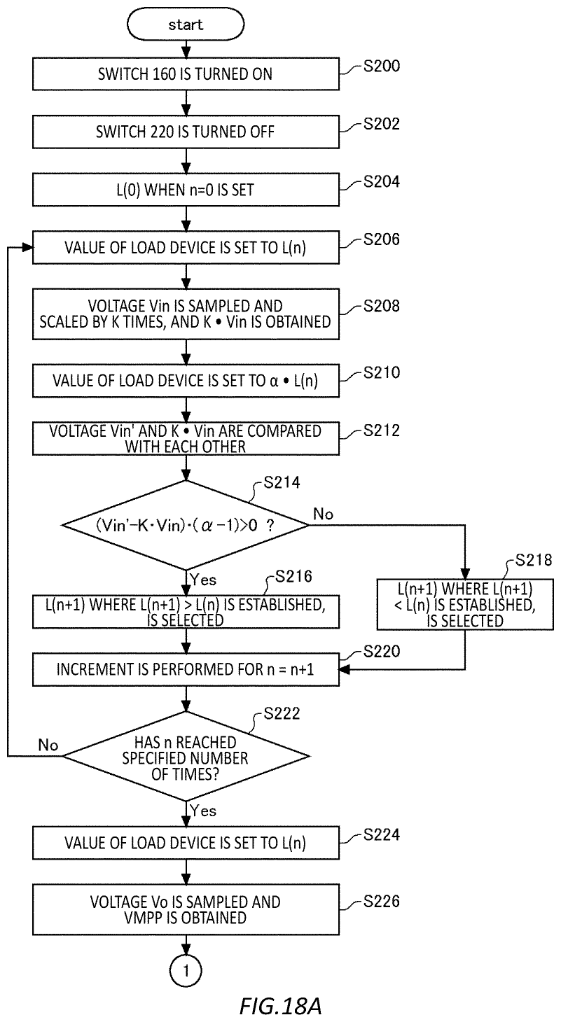

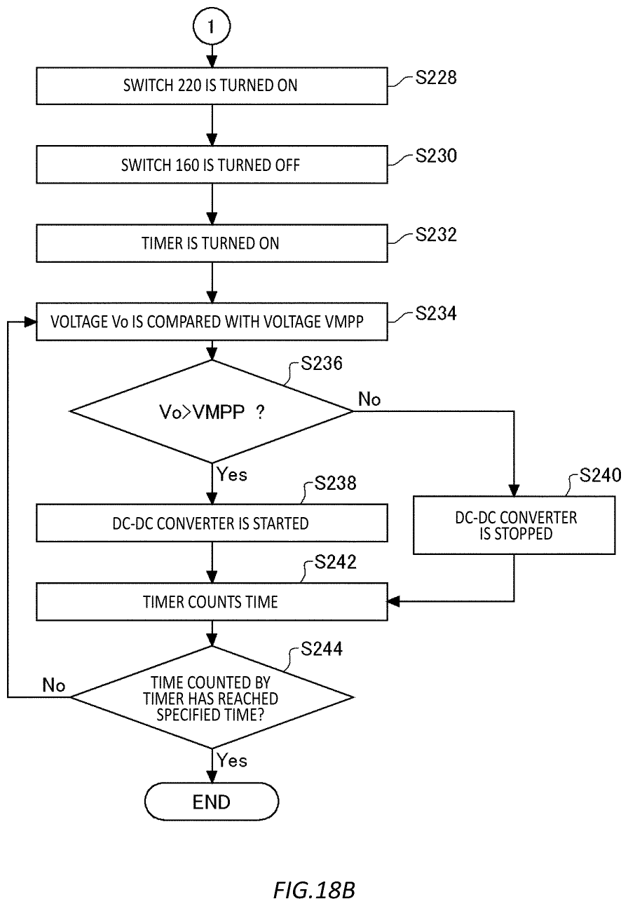

It should be noted that FIG. 18 shows an embodiment in which the scaling device located between the sampling device 120 and the comparator 140 in FIG. 1A is set as a first scaling device 170, and in which a second scaling device 190 is newly arranged between a sampling device 180, and the comparator 140.

In the descriptions of the system 100 according to FIG. 1B, the description of the component elements common to FIG. 1A will be omitted. The following description will focus on a difference in component elements between the embodiment according to FIG. 1A and the embodiment according to FIG. 1B.

The scaling device 170 scales the voltage Vin sampled by the sampling device 120, to A×Vin. On the other hand, the scaling device 190 scales the voltage Vin′ sampled by the sampling device 180 to B×Vin′.

Here, each of A and B may be a predetermined coefficient. In an expression where A/B=K, A is an example of the second coefficient, and B is an example of the third coefficient. For example, when the third coefficient B=1, the second coefficient A=K. As another example, when the second coefficient A=1, the third coefficient B=1/K.

The comparator 140 compares an output A×Vin of the first scaling device 170 with an output B×Vin′ of the second scaling device 190. When the second coefficient A and the third coefficient B are varied under a condition that A/B=K is satisfied, as well, a similar control method can also be realized.

Here, A×Vin, which is obtained by multiplying Vin that is an example of the “first input voltage value”, by A that is an example of the “second coefficient”, is an example of a “first value”. In addition, B×Vin′, which is obtained by multiplying Vin′ that is an example of the “second input voltage value”, by B that is an example of the “third coefficient”, is an example of a “second value”. Further, a ratio A/B where K=A/B is an example of a “determination value”.

It should be noted that when Vin′ is directly input to the scaling device 190 without using the sampling device 180, as well, it is clear that a similar operation occurs. Accordingly, in the system 100 of FIG. 1B, it is possible to omit the sampling device 180 and make a configuration.

Next, a specific example of the variable load of the load device 110a, and the maximum power point being achieved by the control method of FIG. 2 for these loads, will be described in more detail. FIG. 3 is a circuit diagram showing examples of configurations of a power supply 10a and a load device 110b.

The load device 110b is an example of the load device 110a that includes a variable resistor 112b as the variable load. In the drawing of FIG. 3 and the subsequent drawings, a component element referenced with a sign and a numeral, and a component element referenced with the same sign and numeral in another figure, have the same configuration.

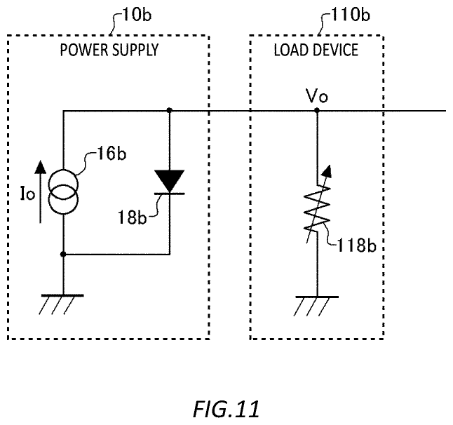

In FIG. 3, parts other than the power supply 10a and the load device 110b are omitted. Note that the power supply 10a and the load device 110b may be connected to other component elements similar to those included in the system 100 described in FIG. 1A. This also applies to FIG. 7, FIG. 9, FIG. 11, or the like.

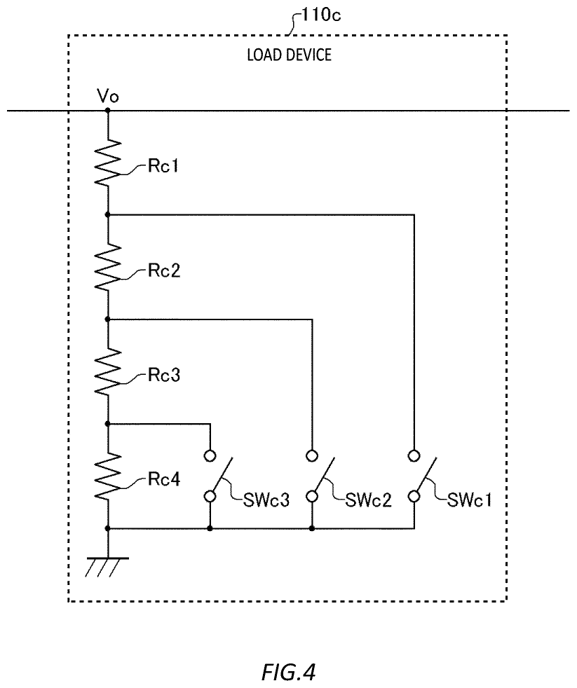

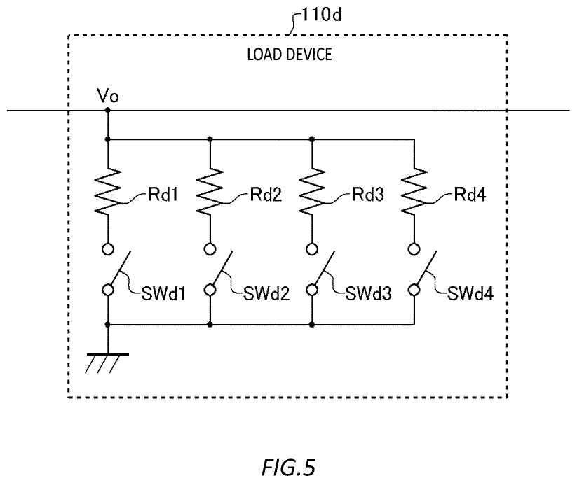

The variable resistor 112b has a resistance value Ri, and one end of the variable resistor 112b is connected to the power supply 10a, and the other end of the variable resistor 112b is grounded. The variable resistor 112b is, as an example, a load device 110c of FIG. 4 or a load device 110d of FIG. 5. Alternatively, the variable resistor 112b may be configured for an on resistance of a MOS.

FIG. 4 is a circuit diagram showing an example of a configuration of a load device 110c. The load device 110c includes resistors Rc1, Rc2, Rc3, Rc4, and switches SWc1, SWc2, SWc3.

The resistors Rc1, Rc2, Rc3, Rc4 are connected in series between a node to which the voltage Vo is applied and a node which is grounded. Further, the switch SWc1 is connected between the node which is grounded and the connection node of Rc1 and Rc2, and the switch SWc2 is connected between the node which is grounded and the connection node of Rc2 and Rc3, and the switch SWc3 is connected between the node which is grounded and the connection node of Rc3 and Rc4.

In the load device 110c, by exclusively turning on the switches SWc1 to SWc3, it is possible to change a combined resistance of the load device 110c, stepwise. When all of the switches SWc1 to SWc3 are turned off, the resistance of the load device 110c is the combined resistance of all of the resistors Rc1, Rc2, Rc3, Rc4. In addition, the load device 110c may use the combined resistance when a plurality of switches among the switches SWc1 to SWc3 are turned on.

FIG. 5 is a circuit diagram showing an example of a configuration of a load device 110d. The load device 110d include resistors Rd1, Rd2, Rd3, Rd4, and switches SWd1, SWd2, SWd3, and SWd4.

The resistors Rd1, Rd2, Rd3, Rd4 are connected in parallel between a node to which the voltage Vo is applied and a node which is grounded. The switch SWd1 is connected between Rd1 and the node which is grounded. Similarly, the switch SWd2 is connected between Rd2 and the node which is grounded, the switch SWd3 is connected between Rd3 and the node which is grounded, and the switch SWd4 is connected between Rd4 and the node which is grounded.

When the resistors Rd1, Rd2, Rd3, Rd4 have resistances different from each other, by exclusively switching the switches SWd1, SWd2, SWd3, SWd4, it is possible to change the resistance of the load device 110d, stepwise. In addition, when the resistors Rd1, Rd2, Rd3, Rd4 have resistances which are the same as or different from each other, by selectively switching the switches SWd1, SWd2, SWd3, SWd4, it is possible to change the combined resistance of the load device 110d, stepwise.

Each of the illustrated load devices 110c, 110d includes four resistors; however, the number of the resistors included in each of the load devices 110c, 110d is an example, and is not limited to four, and the number of the included resistors may be any number. In that case, the number of the switches SWc included in the load device 110c is (the number of resistors)—1; and the number of the switches SWd included in the load device 110d is the same as (the number of the resistors). The load device 110b may be realized by a combination of one or more resistors connected in series to be included in the load device 110c, and one or more resistors connected in parallel to be included in the load device 110d.

Here, with reference to FIG. 3 again, the value of the variable resistance Ri when the maximum power point is achieved will be described. A voltage Vo(Rk) which is applied when the variable resistance Ri=Rk is shown by the following expression,

$$\begin{matrix}[ Math . 1 ] & \\ {V}_{o} ( {R}_{i} = {R}_{k} ) = \frac{{R}_{k}}{{R}_{s} + {R}_{k}} {V}_{s} & ( 1 )\end{matrix}$$

On the other hand, when the load is multiplied by α, that is, the resistance Ri=Rk/α,

$$\begin{matrix}[ Math . 2 ] & \\ {V}_{o} ( {R}_{i} = {R}_{k} / α ) = \frac{{R}_{k} / α}{{R}_{s} + {R}_{k} / α} {V}_{s} & ( 2 )\end{matrix}$$

is established. By respectively dividing both sides of expression (2) by both sides of expression (1),

$$\begin{matrix}[ Math . 3 ] & \\ \frac{{V}_{o} ( {R}_{i} = {R}_{k} / α )}{{V}_{o} ( {R}_{i} = {R}_{k} )} = \frac{{R}_{k} / α}{{R}_{s} + {R}_{k} / α} / \frac{{R}_{k}}{{R}_{s} + {R}_{k}} & ( 3 )\end{matrix}$$

is obtained.

In the circuit of the present embodiment, it is possible to achieve the maximum power point when Ri=Rs. In this case,

$$\begin{matrix}[ Math . 4 ] & \\ \frac{{V}_{o} ( {R}_{i} = {R}_{s} / α )}{{V}_{o} ( {R}_{i} = {R}_{s} )} = \frac{2}{α + 1} & ( 4 )\end{matrix}$$

is satisfied. When Rk>Rs (the overload), a direction of the inequality sign differs depending on the magnitudes of α and 1,

$$\begin{matrix}[ Math . 5 a ] & \\ \frac{{V}_{o} ( {R}_{i} = {R}_{k} / α )}{{V}_{o} ( {R}_{i} = {R}_{k} )} > \frac{2}{α + 1} ( α > 1 ) & ( 5 a )\end{matrix}$$

$$\begin{matrix}[ Math . 5 b ] & \\ \frac{{V}_{o} ( {R}_{i} - {R}_{k} / α )}{{V}_{o} ( {R}_{i} = {R}_{k} )} < \frac{2}{α + 1} ( a < 1 ) & ( 5 b )\end{matrix}$$

are established
On the other hand, when Rk<Rs (the light load),

$$\begin{matrix}[ Math . 6 a ] & \\ \frac{{V}_{o} ( {R}_{i} = {R}_{k} / α )}{{V}_{o} ( {R}_{i} = {R}_{k} )} < \frac{2}{α + 1} ( α > 1 ) & ( 6 a )\end{matrix}$$

$$\begin{matrix}[ Math . 6 b ) & \\ \frac{{V}_{o} ( {R}_{i} = \frac{{R}_{k}}{α} )}{{V}_{o} ( {R}_{i} = {R}_{k} )} > \frac{2}{α + 1} ( α < 1 ) & ( 6 b )\end{matrix}$$

are established.

In a case where the coefficient K in accordance with the coefficient α is used, when the coefficient K by which K=2/(α+1) is established is used, the load is the light load below the maximum power point when [Vo(Ri=Rk/α)−K×Vo(Ri=Rk)]×(α−1)>0, that is, (Vin′−K×Vin)×(α−1)>0. On the other hand, when [Vo(Ri=Rk/α)−K×Vo(Ri=Rk)]×(α−1)<0, that is, (Vin′−K×Vin)×(α−1)<0, the load is the overload beyond the maximum power point.

Using the variable resistor 112b as the load device 110a corresponds to the case where L(n)=1/Rk is established in the flowchart of FIG. 2. In this case, by appropriately setting α and K, Rk can be brought close to Rs which obtains the maximum power point.

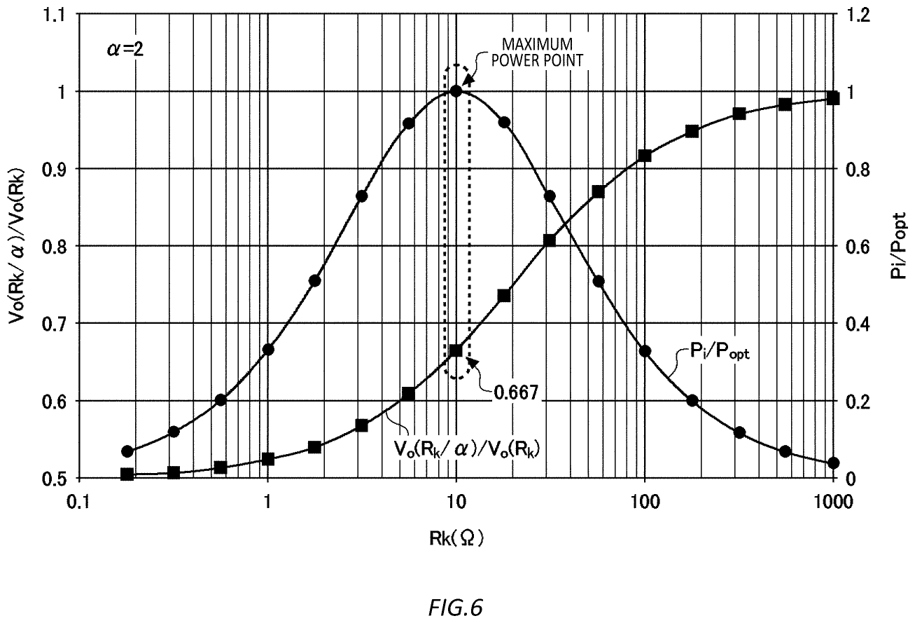

FIG. 6 is a graph showing changes in a voltage ratio Vo(Ri=Rk/α)/Vo(Ri=Rk) and a power ratio Pi/Popt when a resistance Rk(Ω) of the load device 110b changes. The power ratio Pi/Popt is a ratio of the power which is consumed by the load device 110b to the power of the maximum power point. In the figure, as an example, Vs=10V, Rs=10Ω, and α=2 are set.

In the figure, when Rk=10Ω, the maximum power point is achieved in a case where the voltage ratio is K=2/3=0.667. Accordingly, in the flowchart of FIG. 2, when α and K are set appropriately, the system 100 can bring Rk close to the resistance Rs which obtains the maximum power point according to the flowchart.

FIG. 7 is a circuit diagram showing examples of configurations of the power supply 10a and a load device 110e. The load device 110e is an example of the load device 110e that includes a variable current source 114e as the variable load.

The variable current source 114e supplies a current of a current value Ii. One end of the variable current source 114e is connected to the power supply 10a, and the other end of the variable current source 114e is grounded. The variable current source 114e is, as an example, a current output DAC configured by a MOS transistor, a bipolar transistor, a resistor, or the like.

When the current Ii=Ik, a voltage Vo(Ik) which is applied to the load device 110e satisfies

V₀(Iᵢ=Iₖ)=Vₛ−Rₛ·Iₖ [Math. 7]

When the load is multiplied by α, that is, Ii=α×Ik,

V₀(Iᵢ=α·Iₖ)=Vₛ−α·Rₛ·Iₖ [Math. 8]

is established. Accordingly, by respectively dividing both sides of expression (8) by both sides of expression (7),

$$\begin{matrix}[ Math . 9 ] & \\ \frac{{V}_{o} ( {I}_{i} = α \cdot {I}_{k} )}{{V}_{o} ( {I}_{i} = {I}_{k} )} = \frac{{V}_{s} - α \cdot {R}_{s} \cdot {I}_{k}}{{V}_{s} - {R}_{s} \cdot {I}_{k}} & ( 9 )\end{matrix}$$

is obtained.

In the circuit of the present embodiment, it is possible to realize the maximum power point when Ik=Vs/(2×Rs). In this case

$$\begin{matrix}[ Math . 10 ] & \\ \frac{{V}_{o} ( {I}_{i} = α \cdot {I}_{k} )}{{V}_{o} ( {I}_{i} = {I}_{k} )} = 2 - α & ( 10 )\end{matrix}$$

is satisfied. When Ik>Vs/(2×Rs) (the overload), the direction of the inequality sign differs depending on the magnitudes of α and 1,

$$\begin{matrix}[ Math . 11 a ) & \\ \frac{{V}_{o} ( {I}_{i} = α \cdot {I}_{k} )}{{V}_{o} ( {I}_{i} = {I}_{k} )} < 2 - α ( α > 1 ) & ( 11 a )\end{matrix}$$

$$\begin{matrix}[ Math . 11 b ] & \\ \frac{{V}_{o} ( {I}_{i} = α \cdot {I}_{k} )}{{V}_{o} ( {I}_{i} = {I}_{k} )} > 2 - α ( α < 1 ) & ( 11 b )\end{matrix}$$

are established. On the other hand, when Ik<Vs/(2×Rs) (the light load),

$$\begin{matrix}[ Math . 12 a ] & \\ \frac{{V}_{o} ( {I}_{i} = α \cdot {I}_{k} )}{{V}_{o} ( {I}_{i} = {I}_{k} )} > 2 - α ( α > 1 ) & ( 12 a )\end{matrix}$$

$$\begin{matrix}[ Math . 12 b ] & \\ \frac{{V}_{o} ( {I}_{i} = α \cdot {I}_{k} )}{{V}_{o} ( {I}_{i} = {I}_{k} )} < 2 - α ( α < 1 ) & ( 12 b )\end{matrix}$$

are established.

In a case where the coefficient K in accordance with the coefficient α is used, when the coefficient K by which K=2−α is established is used, the load is the light load below the maximum power point when [Vo(Ii=α×Ik)−K×Vo(Ii=Ik)]×(α−1)>0, that is, (Vin′−K×Vin)×(α−1)>0. On the other hand, when [Vo(Ii=α×Ik)−K×Vo(Ii=Ik)]×(α−1)<0, that is, (Vin′−K×Vin)×(α−1)<0, the load is the overload beyond the maximum power point.

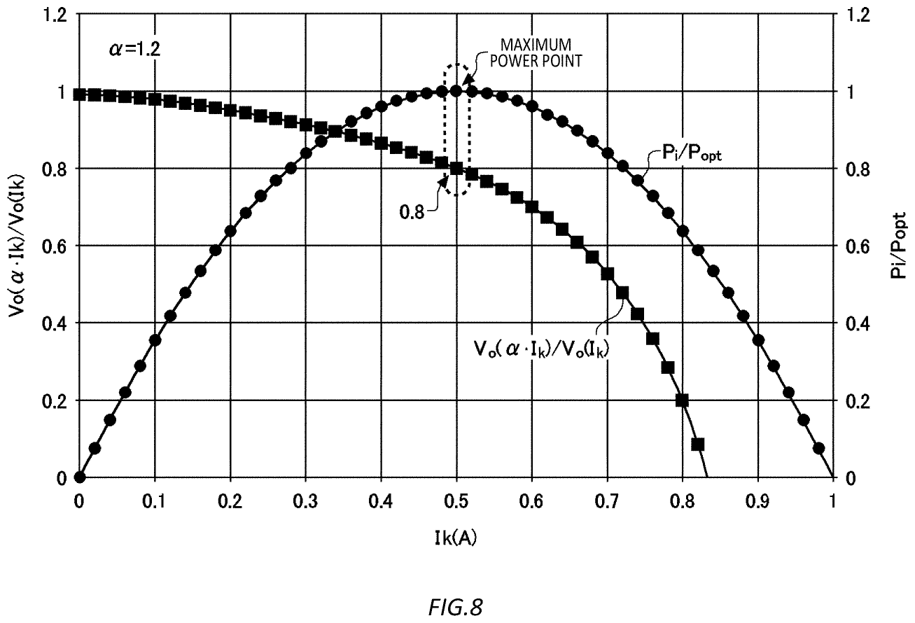

FIG. 8 is a graph showing changes in a voltage ratio Vo(α×Ik)/Vo(Ik) and the power ratio Pi/Popt when a current Ik(A) of the load device 110e changes. In the figure, as an example, Vs=10V, Rs=10Ω, and α=1.2 are set.

In the figure, when Ik=0.5 A, the maximum power point is achieved in a case where the voltage ratio is K=2−1.2=0.8. Accordingly, in the flowchart of FIG. 2, when α and K are set appropriately as L(n)=Ik, the system 100 can bring Rk close to the resistance Rs which obtains the maximum power point according to the flowchart.

FIG. 9 is a circuit diagram showing examples of configurations of the power supply 10a and a load device 110f. The load device 110f is an example of the load device 110f that includes a variable power load 116f as the variable load.

The variable power load 116f consumes the power of a power value Pi. One end of variable power load 116f is connected to the power supply 10a, and the other end of variable power load 116f is grounded. When CC charging (constant current charging) is performed from the variable power load 116f to a power storage device such as the lithium ion battery (LIB), for example, the voltage change of the power storage device is very gradual. Accordingly, the CC charging within a certain period of time is considered to be constant voltage charging or constant power charging, and the CC charging is equivalent to charging the power storage device with the constant power. In addition, when the DC-DC converter that realizes the CC charging is highly efficient, and the DC-DC converter that performs the CC charging is considered to be the load, the load can be considered to be the variable power load that can vary the power by the charging current.

When the power Pi=Pk, a voltage Vo(Pk) which is applied to the load device 110f satisfies

$$\begin{matrix}[ Math . 13 ] & \\ {V}_{o} ( {P}_{i} = {P}_{k} ) = \frac{1}{2} ( {V}_{s} + \sqrt{{V}_{s}^{2} - 4 \cdot {R}_{s} \cdot {P}_{k}} ) & ( 13 )\end{matrix}$$

When the load is multiplied by α, that is, Pi=α×Pk,

$$\begin{matrix}[ Math . 14 ] & \\ {V}_{o} ( {P}_{i} = α \cdot {P}_{k} ) = \frac{1}{2} ( {V}_{s} + \sqrt{{V}_{s}^{2} - 4 α \cdot {R}_{s} \cdot {P}_{k}} ) & ( 14 )\end{matrix}$$

is established. Accordingly, by respectively dividing both sides of expression (14) by both sides of expression (13),

$$\begin{matrix}[ Math . 15 ] & \\ \frac{{V}_{o} ( {P}_{i} = α \cdot {P}_{k} )}{{V}_{o} ( P = {P}_{k} )} = \frac{{V}_{s} + \sqrt{{V}_{s}^{2} - 4 α \cdot {R}_{s} \cdot {P}_{k}}}{{V}_{s} + \sqrt{{V}_{s}^{2} - 4 \cdot {R}_{s} \cdot {P}_{k}}} & ( 15 )\end{matrix}$$

is obtained.

In the circuit of the present embodiment, it is possible to realize the maximum power point when Pk=(Vs\hat{ }2)/(2×Rs). In this case,

$$\begin{matrix}[ Math . 16 ] & \\ \frac{{V}_{o} ( {P}_{i} = α \cdot {P}_{k} )}{{V}_{o} ( {P}_{i} = {P}_{k} )} = 1 + \sqrt{1 - α} ( 0 < α < 1 ) & ( 16 )\end{matrix}$$

is satisfied. When Pk<(Vs\hat{ }2)/(2×Rs) (the light load),

$$\begin{matrix}[ Math . 17 ] & \\ \frac{{V}_{o} ( {P}_{i} = α \cdot {P}_{k} )}{{V}_{o} ( {P}_{i} = {P}_{k} )} < 1 + \sqrt{1 - α} ( 0 < α < 1 ) & ( 17 )\end{matrix}$$

is established. The power supply cannot supply the power by which Pk>(Vs\hat{ }2)/(2×Rs) is established, and thus there is no operating point at which the load is the overload. In addition, the maximum power point of Pk=(Vs\hat{ }2)/(2×Rs) is an unstable operating point. Accordingly, it is desirable for K to be lower than or equal to 1+√(1−α). That is, K may be set to 1+√(1−α), or may be set to a value which provides a stable operating point which is smaller than 1+√(1−α).

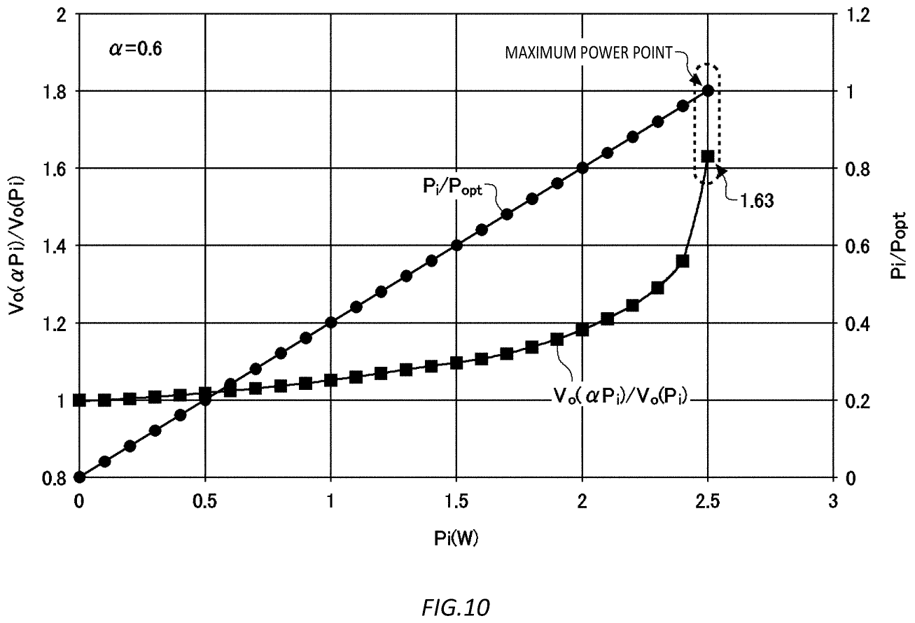

FIG. 10 is a graph showing changes in a voltage ratio Vo(α×Pk)/Vo(Pk) and the power ratio Pi/Popt when power Pk(W) of the load device 110f changes. In the figure, as an example, Vs=10V, Rs=10Ω, and α=0.6 are set.

In the figure, when the maximum power Pk=2.5W, the maximum power point is achieved when the voltage ratio is 1.63. However, this is an unstable point, and it is desirable that approximately K=1.4 which is slightly smaller than that. Accordingly, in the flowchart of FIG. 2, when a and K are set appropriately as L(n)=Pk, the system 100 can bring Rk close to the resistance Rs which obtains the maximum power point according to the flowchart.

FIG. 11 is a circuit diagram showing examples of configurations of a power supply 10b and the load device 110b when a solar cell is used as the power supply 10b. When the power supply 10b is the solar cell, the power supply 10b includes a constant current source 16b for the current which is generated by receiving light, and a diode 18b connected in parallel to the constant current source 16b.

In the figure, the variable resistor of the load device 110b is shown as a variable resistor 118b. The variable resistor 118b may have a resistance value different from the variable resistor 112b in FIG. 2, but may be set to have the same resistance value as that of the variable resistor 112b according to the current which is output from the power supply 10b. Accordingly, a range of a variation in the resistance value of the variable resistor 118b may overlap a range of a variation in the resistance value of the variable resistor 112b.

The internal resistance inside the power supply 10b depends on the load, and thus the expression satisfied by the power consumption or the like in the circuit of FIG. 11 behaves differently from the calculation expressions shown in up to FIG. 10. The description that when such a power supply 10b is used, as well, the same estimation of the maximum power as that in the embodiments already described is available, will be made.

The current which is output from the power supply 10b satisfies

I=I₀−Iₛ{exp(kV/T)−1} [Math. 18].

Here, I₀ is the current value from the constant current source 16b for the current that is generated by receiving the light, and Is is a current value of a reverse saturation current of the diode 18b. k is a constant specific to the diode, V is an output voltage value of the solar cell, and T is an absolute temperature.

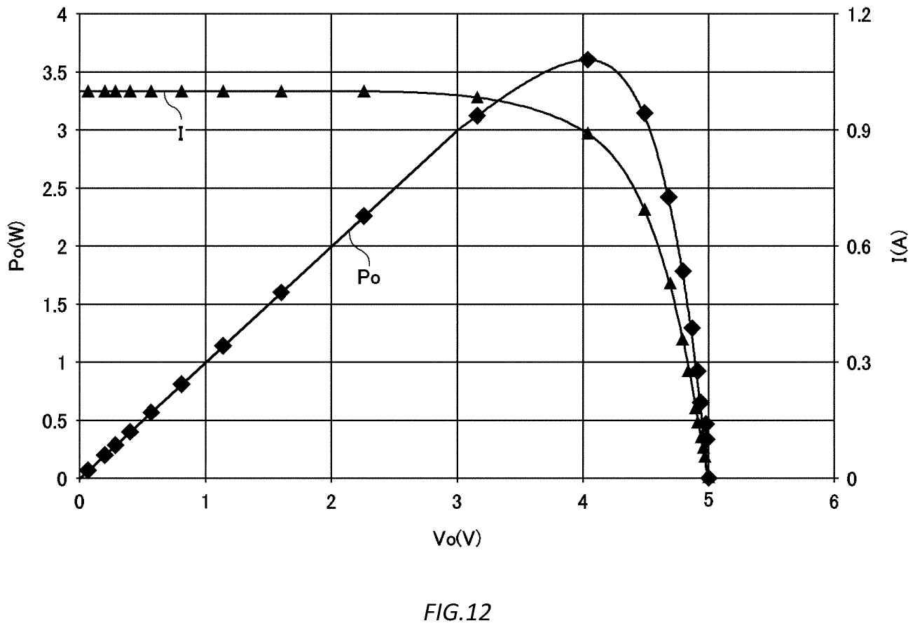

FIG. 12 is a graph showing examples of an output current I and power Po which is consumed by the load, with respect to an output voltage Vo, when an arbitrary load is connected to the power supply 10b. In the power supply 10a including the voltage source 12a and the resistor 14a shown in FIG. 1A to FIG. 10, the maximum power can be obtained at a load in which the operating voltage is 50% of the open-circuit voltage. On the other hand, in the solar cell, as shown in FIG. 12, maximum power can be obtained at a load in which an operating voltage is approximately 80% of the open-circuit voltage.

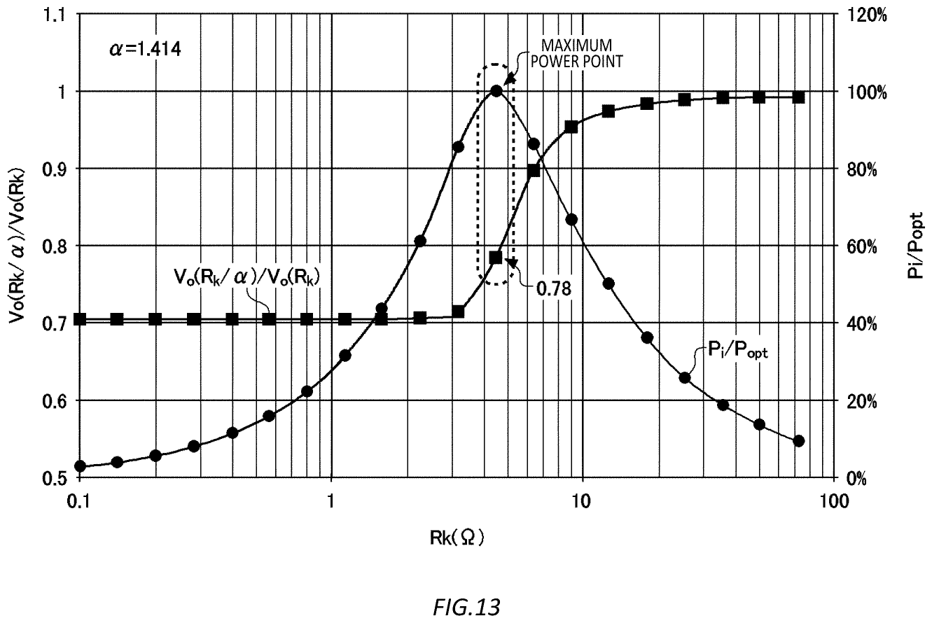

FIG. 13 is a graph showing changes in the voltage ratio Vo(Rk/α)/Vo(Rk) and the power ratio Pi/Popt when the load device 110b is connected to the power supply 10b. In the figure, as an example, α is set to 1.414.

In the figure, the maximum power point is achieved when the voltage ratio Vo(Ri=Rk/α)/Vo(Ri=Rk) is 0.78. As described above, by setting α=1.414 and K=0.78, the maximum power point can be achieved as before.

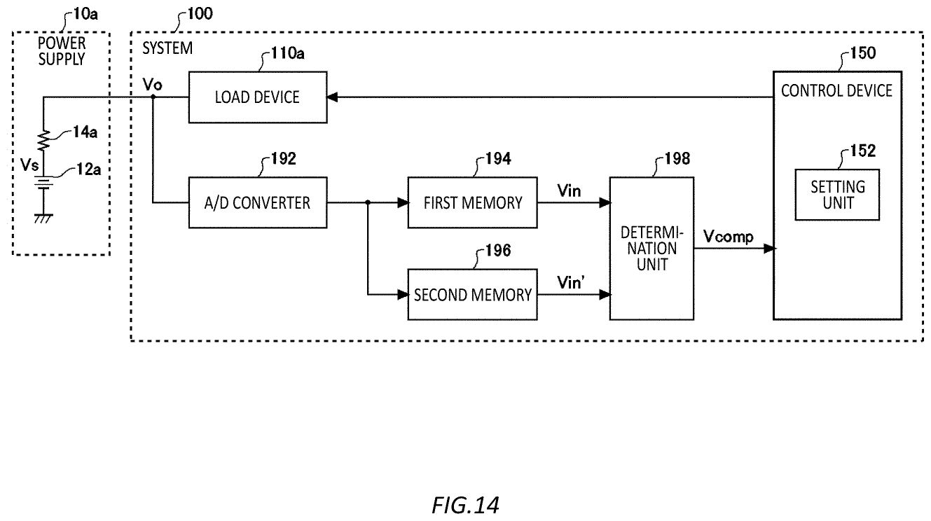

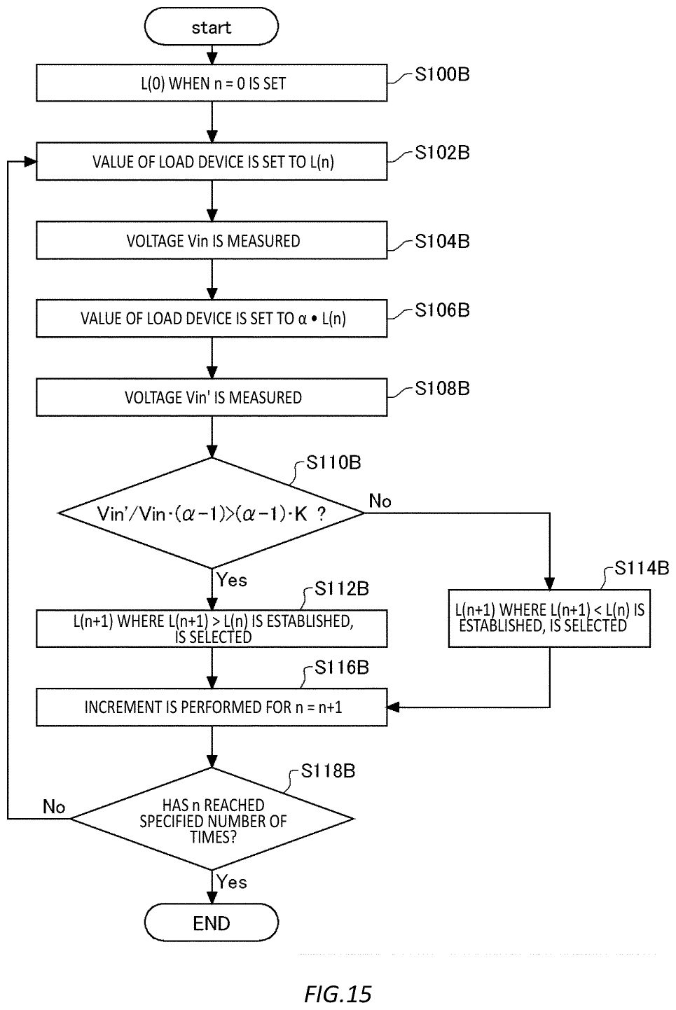

By using the flowchart and the mathematical expression, the above description that when the resistive load, the current load, or the power load is used as the load in the load device 110, the maximum operating power point can be achieved by the method of the present invention, has been made. The method for determining whether the load is the light load or the overload may not be based on FIG. 2, and may be performed, as derived from expressions (5a), (5b), (6a), (6b), (11a), (11b), (12a), (12b), (16, 17), by determining processing performed between the coefficient k and the voltage ratio in which a numerator is set to the voltage Vin when any load amount L(n) is connected, and a denominator is set to the voltage Vin′ when an α times the load amount of α×L(n) is connected. The configuration of the system 100 that is used in this case will be described with reference to FIG. 14, and the operation thereof will be described with reference to the flowchart of FIG. 15.

Here, FIG. 14 shows an embodiment of the system 100 that includes an A/D converter 192, a first memory 194, a second memory 196, and a determination unit 198, instead of the sampling device 120, the scaling device 130, and the comparator 140 in FIG. 1A. As other component elements, the system 100 in FIG. 14 includes the load device 110a and the control device 150, and is connected to the power supply 10a, similarly to the configuration in FIG. 1A. The functions of A/D converter 192, the first memory 194, the second memory 196, and the determination unit 198 will be described in detail with reference to FIG. 15.

FIG. 15 is a flowchart showing the operation of the system 100 in FIG. 14. By the operation of the system 100, a control method is implemented to control the load amount of the load device 110 that receives the supply of the power which is output from the power supply 10, so as to achieve the maximum power point. One sequence may be set from a START to an END in the flowchart, and the sequence may be performed only once, or may be performed multiple times in succession. The control method represented by the sequence in the figure includes steps S100B to S118B.

First, the control device 150 sets a load L(0) when n=0 for the load amount L(n) of the load device 110 (S100B). Next, the control device 150 sets the load amount of the load device 110 to the load amount L(n) (S102B). Here, n is an integer equal to or larger than zero. For the number of times of executions of the sequence, when the sequence is executed for the first time, the control device 150 may set the load amount of the load device 110 to L(0). In the second and subsequent sequences, the control device 150 uses a last value of a previous sequence, as the load L(n).

Next, the A/D converter 192 converts, into the digital value Vin, the voltage Vo which is a measurement target when the load device 110 has the load amount L(n). The first memory 194 stores the digital value Vin as a measured value (S104B).

Further, the control device 150 sets the load amount of the load device 110 to the amount of the load α×L(n) (S106B). The A/D converter 192 converts, into the digital value Vin′, the voltage Vo which is the measurement target when the load amount of the load device 110 is α×L(n). The second memory 196 stores the digital value Vin′ as a measured value (S108B).

Next, the determination unit 198 determines whether the inequality Vin′/Vin×(α−1)>(α−1)×K is satisfied, and outputs a determination result to the setting unit 152 as Vcomp (S110B).

If it is determined by the determination unit 198 that the inequality Vin′/Vin×(α−1)>(α−1)×K is satisfied, the setting unit 152 sets the load amount of the load device 110 to the load amount L(n+1) which is larger than L(n) (that is, L(n+1)>L(n) is satisfied) (S112B). After this, the processing proceeds to S116A.

If it is determined by the determination unit 198 that the inequality Vin′/Vin×(α−1)>(α−1)×K is not satisfied, the setting unit 152 sets the load amount of the load device 110 to the load amount L(n+1) which is smaller than L(n) (that is, L(n+1)<L(n) is satisfied) (S114B). After this, the processing proceeds to S116B.

The setting unit 152 increments the value of n to n=n+1 (S116B). Next, the setting unit 152 compares n with a predetermined threshold value and determines whether the value of n is larger than or equal to the predetermined threshold value (a specified number of times) (S118B).

If n reaches the specified number of times, the setting unit 152 ends the processing of the load amount L(n) (S118B). If n does not reach the specified number of times, the setting unit 152 returns the processing to S102B, and the system 100 performs the processing from S102B to S118B again.

As described above, the processing from S102B to S118B is repeated until n reaches the specified number of times. In a case where the processing from the START to the END until n reaches the specified number of times is set as one sequence, the load amount L(n) of the load device 110 is increased or decreased through this sequence, and approaches L(n) which realizes the maximum amount of power. This approaching value is L(n) of the maximum power point.

It should be noted that the first memory 194, the second memory 196, and the determination unit 198 in FIG. 14 and FIG. 15 may be configured by using a logic gate circuit or a microprocessor.

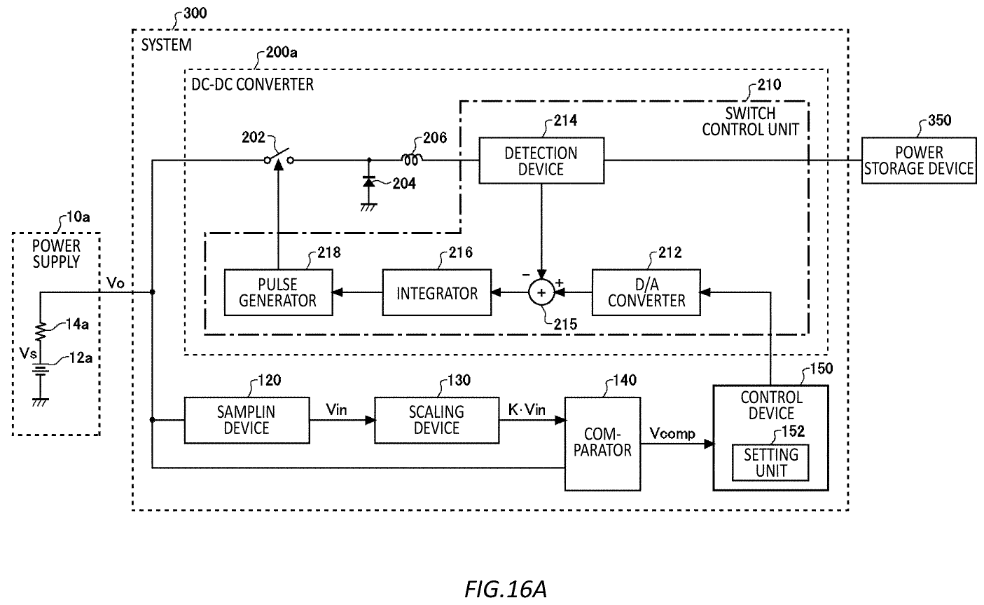

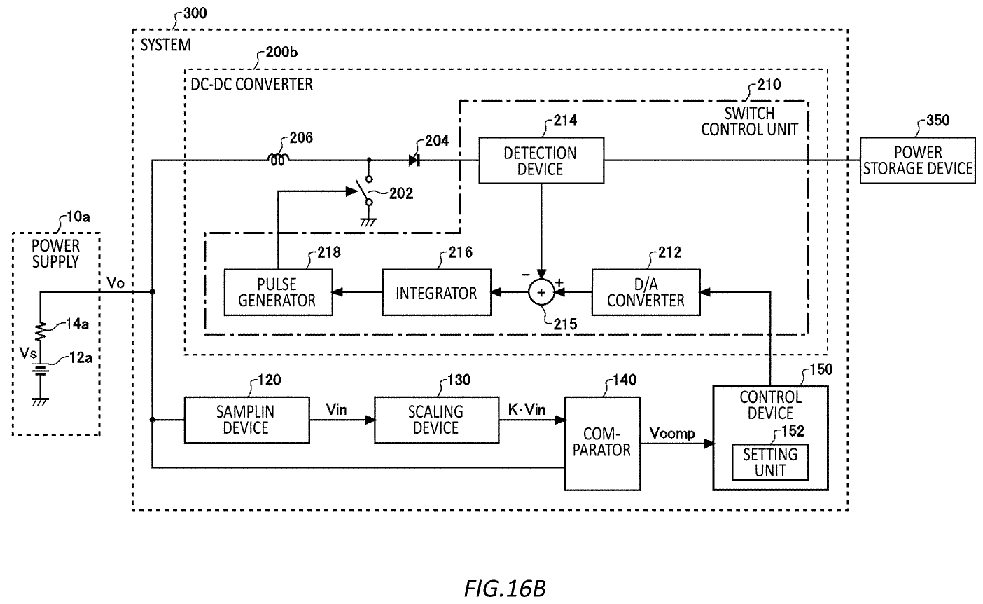

FIG. 16A is a block diagram showing an example of a configuration of a system 300 by using a DC-DC converter 200a as the load device. The system 300 of the present embodiment corresponds to a system in which the load device 110a is replaced with the DC-DC converter 200a, in the system 100 of FIG. 1A. Accordingly, the system 300 includes the sampling device 120, the scaling device 130, the comparator 140, and the control device 150, and includes the DC-DC converter 200a instead of the load device 110a. In addition, a power storage device 350 is connected to the output of the DC-DC converter 200a.

The power storage device 350 includes, as an example, the LIB. When the DC-DC converter 200a performs the CC charging on the power storage device 350, as already described with reference to FIG. 9, the CC charging within a certain period of time is considered to be the constant voltage charging or the constant power charging. The DC-DC converter 200a can be considered to be the variable power load that charges the power storage device with the constant power within a certain period of time.

The DC-DC converter 200a is the DC-DC converter of the step-down type that causes a current having a current value of a target level, to flow into the power storage device 350, and supplies the DC voltage. An input terminal (not shown) of the DC-DC converter 200a is connected to the power supply 10a, and an output terminal (not shown) of the DC-DC converter 200a is connected to the power storage device 350. Further, the DC-DC converter 200a includes a terminal into which a target current value for controlling the operation of the DC-DC converter 200a is input, and this terminal is connected to the setting unit 152.

The DC-DC converter 200a includes a switch 202, a diode 204, an inductor 206, and a switch control unit 210. In the present embodiment, the DC-DC converter of the step-down type is used as the DC-DC converter 200a; however, in an alternative embodiment, a DC-DC converter 200b of the step-up type which will be described below may be used as the DC-DC converter. The DC-DC converter 200a and the DC-DC converter 200b correspond to a “voltage conversion device”.

The switch 202 controls a direct current flowing through the inductor 206. In the present embodiment, the switch 202 controls the input to a subsequent circuit. Specifically, the switch 202 is turned on or turned off for the direct current which is input from the power supply 10a to the inductor 206. One end of the switch 202 is connected to the power supply 10a via one of the terminals of the DC-DC converter 200a.

The switch 202, the diode 204, and the inductor 206 constitute a step-down chopper circuit. A cathode of the diode 204, and the inductor 206 are connected to the other end of the switch 202. An anode of the diode 204 is grounded.

The direct current which is supplied by the power supply 10a flows through the inductor 206. In the case of the DC-DC converter 200a of the step-down type of the present embodiment, the direct current is input to the inductor 206 via the switch 202. The inductor 206 is connected to the output terminal of the DC-DC converter 200a via the switch control unit 210.

As a specific operation of the step-down chopper circuit, when the switch 202 is on, the energy is stored in the inductor 206. On the other hand, when the switch 202 is off, the energy is released from the inductor 206. The released energy flows from the ground (GND) via the diode 204 through the inductor 206 to the power storage device 350, and charges the power storage device 350. The amount of current which flows into the power storage device 350 depends on an on time of the switch 202, and a pulse frequency of a pulse which is formed by the switch 202 being turned on and turned off. When the on time of the switch 202 is long and the pulse frequency is high, the current flowing into the battery is increased.

The switch control unit 210 controls an on and off timing of the switch 202, based on the current flowing from the inductor 206 and the input from the setting unit 152. The switch control unit 210 includes a D/A converter 212, a detection device 214, an adder 215, an integrator 216, and a pulse generator 218.

The D/A converter 212 performs a D/A conversion on a signal in relation to a target value of the current from the setting unit 152, and inputs the converted signal to the adder 215. As described with reference to FIG. 1A to FIG. 10, the setting unit 152 outputs a signal for setting the load amount of the DC-DC converter 200a, according to the load being light or heavy. An adjustment of the load amount of the DC-DC converter 200a corresponds to an adjustment of the power which is output from the DC-DC converter 200a. Accordingly, the switch control unit 210 can use the signal of the setting unit 152 as a signal in relation to the target value of the current value flowing through the inductor 206 of the DC-DC converter 200a.

The detection device 214 detects the current flowing through the inductor 206 and outputs the signal based on a detection result. Next, the adder 215 calculates a difference between the current value of the current flowing through the inductor 206, and the target value of the current flowing through the inductor 206, and outputs a signal based on the difference, to the integrator 216. Next, the integrator 216 calculates a time integral for the difference calculated by the adder 215, and outputs a signal in accordance with an integration result, to the pulse generator 218.

The pulse generator 218 generates a pulse for an on and off control of the switch 202 according to the integration result of the integrator 216. A pulse width of the pulse which is generated by the pulse generator 218 corresponds to a width of the switching on time of the switch 202. In this manner, the pulse width and the pulse frequency of the pulse which is output from the switch 202, are controlled.

As described above, the switch control unit 210 controls the current which is output from the switch 202, based on the amount of current which is output from the switch 202 and flows through the inductor 206. Accordingly, this control forms a feedback loop. The feedback loop is operated such that the current value detected by the detection device 214, and the target value of the current, are equal to each other. Accordingly, the DC-DC converter 200a can charge the power storage device 350 by the current value in accordance with the target value which is output by D/A converter 212.

In the power storage device 350 during the charge, the voltage is increased by the charging current. However, when the charging time is short, the voltage change is small, which can be considered approximately to be charging by the constant voltage. Accordingly, charging by this feedback loop is charging by the power value in accordance with the target value of the current. Further, in the DC-DC converter with a high efficiency, the input power and the output power are approximately equal, and thus when the DC-DC converter 200a is the DC-DC converter with a high efficiency, the DC-DC converter 200a can be considered to be the variable power load.

Accordingly, the system 300 can perform the load control for achieving the maximum power point, similarly to the embodiments described in FIG. 9 and FIG. 10. As described above, the system 300 can charge the power storage device 350 with the power close to the maximum power point.

FIG. 16B is a block diagram showing another example of the configuration of the system 300 by using the DC-DC converter 200b as the load device. In FIG. 16B, the system 300 uses the DC-DC converter 200b of the step-up type, unlike the example of FIG. 16A in which the DC-DC converter 200a of the step-down type is used.

In the DC-DC converter 200b, a connection relationship between the switch 202, the diode 204, and the inductor 206 is different from that of the DC-DC converter 200a. In this manner, the switch 202, the diode 204, and the inductor 206 of the DC-DC converter 200b constitute a chopper circuit of a step-up type.

The chopper circuit of the step-up type has a different connection relationship from that of the chopper circuit of the step-down type, and thus in each case where the switch 202 is turned on or turned off, the configuration of the circuit that is configured between the power supply 10a or the ground, and the circuit output via the inductor 206 is different. On the other hand, the DC-DC converter 200a of the step-down type is similar to the DC-DC converter 200b of the step-up type in that the switch 202 controls the direct current flowing through the inductor 206.

One end of the inductor 206 of the DC-DC converter 200b is connected to the power supply 10a. On the other hand, the other end of the inductor 206 is connected to the anode of the diode 204 and one end of the switch 202. In addition, the other end of the switch 202 is grounded, and the cathode of the diode 204 is connected to the switch control unit 210.

When the DC-DC converter 200b of the step-up type is used, as well, the power storage device 350 can be charged with the approximately constant voltage, similarly to the DC-DC converter 200a of the step-down type. When the DC-DC converter 200b of a high efficiency is used, the DC-DC converter 200b can be considered to be the variable power load.

Accordingly, when the DC-DC converter 200b is used, as well, the system 300 can perform the load control for achieving the maximum power point, similarly to the embodiments described in FIG. 9 and FIG. 10. As described above, the system 300 can charge the power storage device 350 with the power close to the maximum power point.

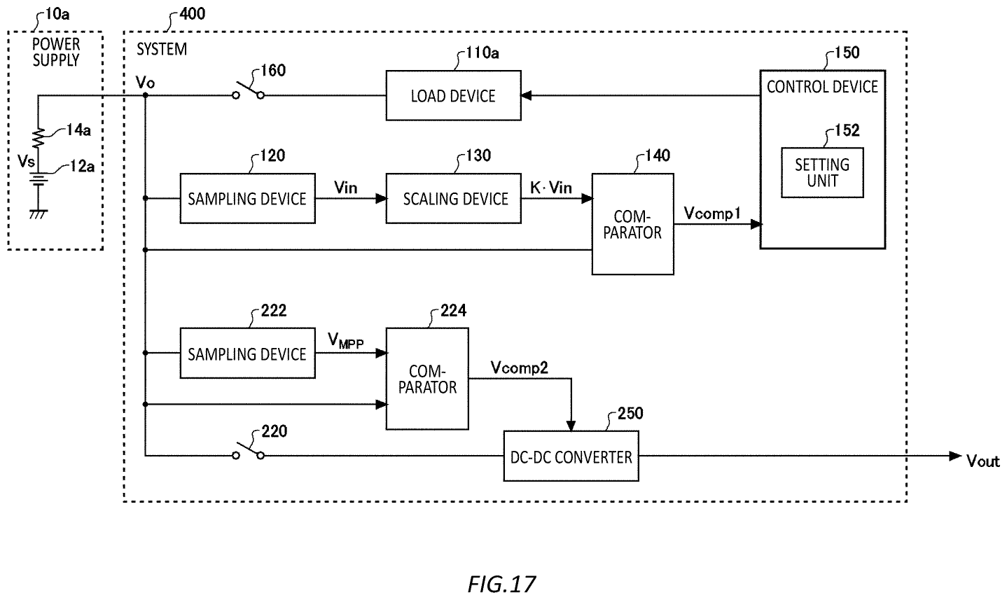

FIG. 17 is a block diagram showing an example of a configuration of a system 400. The system 400 includes a switch 160, the load device 110a, the sampling device 120, the scaling device 130, the comparator 140, and the control device 150, as a configuration corresponding to that of the system 100. Further, the system 400 includes a switch 220, a sampling device 222, a comparator 224, and a DC-DC converter 250.

The load device 110a of the system 400 functions as the dummy load. The load device 110a is connected to the power supply 10a via switch the 160, and consumes the energy which is supplied from the power supply 10a when the switch 160 is on. Similarly to the system 100, the load of the load device 110a of the system 400 may be the variable resistor, the variable current source, or the variable power load.

The switch 160 is turned on or turned off for the input of the direct current from the power supply 10a to the load device 110a. First, when the switch 160 is turned on and the switch 220 is turned off, the sampling device 120, the scaling device 130, the comparator 140, and the control device 150 adjust the variable load of the load device 110a, similarly to the system 100 of FIG. 1A and FIG. 2.

The setting unit 152 sets the variable load of the load device 110a, based on a signal Vcomp1 which is output by the comparator 140. In this manner, the setting unit 152 performs the estimation of the maximum power point on the variable load of the load device 110a, until n becomes larger than or equal to a specified number of times. It should be noted that the signal Vcomp1 which is output from the comparator 140 corresponds to the signal Vcomp of the system 100, but is referred to as the signal Vcomp1 in the system 400 in order to be distinguished from a signal Vcomp2 which will be described below.

Next, the sampling device 222 samples, as a voltage V_{MPP}, the voltage Vo when the variable load provides the maximum power point. Subsequently, when the switch 160 is turned off and the switch 220 is turned on, the system 400 controls the operation of the DC-DC converter 250.

The comparator 224 compares the voltage V_{MPP} with the voltage Vo which is applied from the power supply 10a with the DC-DC converter 250 being set as the load. In this way, the comparator 224 sets a value of the voltage V_{MPP} as a reference voltage value, compares the reference voltage value with the voltage Vo, and outputs the signal Vcomp2 having the logic level which differs depending on a comparison result.

The DC-DC converter 250 may have a similar configuration to that of the DC-DC converter 200a or the DC-DC converter 200b. In addition, when the value of the voltage Vo is larger than or equal to the value of the voltage V_{MPP}, a switch control unit (not shown) in the DC-DC converter 250 executes the on and off control of a switch (not shown) connected to the input of the DC-DC converter 250, based on the signal Vcomp2. On the other hand, when the voltage Vo is smaller than the voltage V_{MPP}, the switch control unit does not execute the on and off control of the switch.

The switch 160 corresponds to a “first switch”. In addition, the switch 220 corresponds to a “second switch”.

FIG. 18A is a flowchart showing an example of a first half of an operation sequence of the system 400. The operation sequence shown in the figure includes steps S200 to S226. A part of FIG. 18A is common to FIG. 2, and thus the description below will mainly focus on a difference from FIG. 2.

First, the system 400 turns on the switch 160 to set the load of the load device 110a which is the dummy load (S200). On the other hand, in the system 400, a DC-DC converter 250 side is turned off. Therefore, the system 400 turns off the switch 220 (S202). S200 and S202 may be performed at the same time, or may be performed in reverse order.

The steps S204 to S222 which are subsequently performed are similar to the steps S100A to S118A in FIG. 2, except that the load of the load device 110a is the dummy load, and thus the description will be omitted. By performing S204 to S222 a specified number of times, the maximum power point is achieved when the specified number of times is taken to be sufficiently large. Here, in a case where the maximum power point is not reached by performing the sequence from S204 to S222 once, the sequence from S204 to S222 may be repeated multiple times.

Next, the setting unit 152 sets the load amount of the load device 110a to the load amount L(n) when the maximum power point is achieved (S224). In this case, the sampling device 222 samples, as the voltage V_{MPP}, the voltage Vo when the variable load provides the maximum power point. The subsequent control is continued to FIG. 18B.

FIG. 18B is a flowchart showing an example of a second half of the operation sequence of the system 400. The control which is performed by the system 400 and is continued from S224, is shown. The operation sequence shown in the figure includes steps S228 to S244.

First, the system 400 turns on the switch 220, to turn on the DC-DC converter 250 side (S228). On the other hand, the system 400 turns off the switch 160 to disconnect the load device 110a which is the dummy load (S230).

Next, the system 400 turns on a timer (not shown) (S230). The timer counts a period during which the following steps S234 to S242 are performed. The timer may be provided inside the system 400, or may be provided outside the system 400.

The comparator 224 compares the voltage V_{MPP} with the voltage Vo when the DC-DC converter 250 is set as the load (S234). The comparator 224 outputs the signal Vcomp2 of the logic level which differs depending on whether Vo>V_{MPP} is established (S236).

The switch control unit in the DC-DC converter 250 executes the on and off control of the switch of the DC-DC converter 250, if Vo>V_{MPP} is established, based on the logic level of the signal Vcomp2. In this way, the system 400 starts the DC-DC converter 250 (S238). Next, the control of the system 400 is continued to S242.

On the other hand, if Vo≤V_{MPP}, the switch control unit does not execute the on and off control of the switch. In this manner, the system 400 stops the DC-DC converter 250 (S240). Next, the control of the system 400 is continued to S242.

Next, the timer counts an elapsed time (S242), and it is determined whether the time counted by the timer has reached a specified time (S244), and if the specified time has been reached, the processing ends, and if the specified time has not been reached, the processing returns to S234. In S234 to S242, the start or the stop of the DC-DC converter 250 is repeated for the voltage Vo to be equal to the input voltage value V_{MPP} for achieving the maximum power point. That is, the switch control unit repeats the conditional processing from S236 to S242, based on whether the condition of S236 is satisfied, until the time counted by the timer reaches the specified time. In this manner, the system 400 extracts the power from the DC-DC converter 250 at the maximum power point from the power supply 10a.

By the processing of S230, S242, S244 in relation to the timer, the DC-DC converter 250 is operated at the maximum power point for the specified time of the timer. The specified time of the timer may be determined by taking account of a voltage holding characteristic of the sampling device 222, a speed of a temporal change in the open-circuit voltage of the power supply, a speed of a temporal change in the output resistance, or the like.

Here, the entire step through the steps S200 to S244 shown in FIG. 18A and FIG. 18B can be set as one sequence. If a specified number of times of n from S204 to S222 is increased, a precision of the maximum power point reached in one sequence is enhanced. On the other hand, the increase in the specified number of times of n results in an increase in the time which is used for the estimation of the maximum power point.

Accordingly, there is a trade off relationship between the estimation precision of the maximum power point, and the estimation efficiency. In a case where the sequence is continuously repeated, even when the maximum power point is not reached in one sequence, the maximum power point can be reached in a plurality of sequences, and thus the maximum power point may not be reached in one sequence. A user of the system 400 can optimize the balance between the estimation precision and the estimation efficiency, by setting the specified number of times and the number of times of repetitions of the sequence, as desired.

The present embodiment has described a case in which the sampling device 120 and the scaling device 130, and the comparator 140 are operated at the same time; and the sampling device 222 and the comparator 224 are operated at the same time. Note that the sampling performed by the sampling device 120, the sampling performed by the sampling device 222, the comparison by the comparator 140, and the comparison by the comparator 224 do not need to be performed at the same time, respectively. That is, any of these combinations may be performed in a time sharing manner.

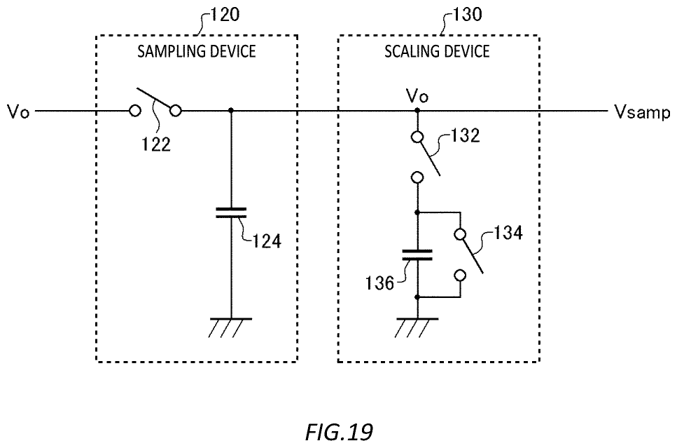

FIG. 19 is a circuit diagram showing examples of configurations of a sampling device 120 and a scaling device 130. The sampling device 120 includes a switch 122 and a capacitor 124. The scaling device 130 includes a switch 132, a switch 134, and a capacitor 136.

The switch 122 is turned on when the load device 110a is set to the load amount L(n). One end of the switch 122 is connected to the power supplies 10a, 10b, and the voltage Vo is supplied from the power supplies 10a, 10b. Accordingly, the voltage Vo from the power supplies 10a, 10b is connected via the switch 122 to a voltage Vsamp which is the output of the scaling device 130.

The capacitor 124 is a capacitor that stores an electric charge which is supplied from the switch 122. One of electrodes of the capacitor 124 is connected to the other end of the switch 122, and the other electrode of the capacitor 124 is grounded.

The voltage based on the electric charge accumulated in the capacitor 124 is input to the scaling device 130, and the voltage scaled by the operation of the circuit after the switch 132 is output. Accordingly, one end of switch 132 is connected to a node between the input and the output of scaling device 130.

The capacitor 136 is a capacitor for accumulating the electric charge when switch 132 is on and the switch 134 is off, thereby scaling the voltage which is output from the scaling device 130. The switch 134 and one of the electrodes of the capacitor 136 are connected to the other end of the switch 132. The other electrode of capacitor 136 is grounded.

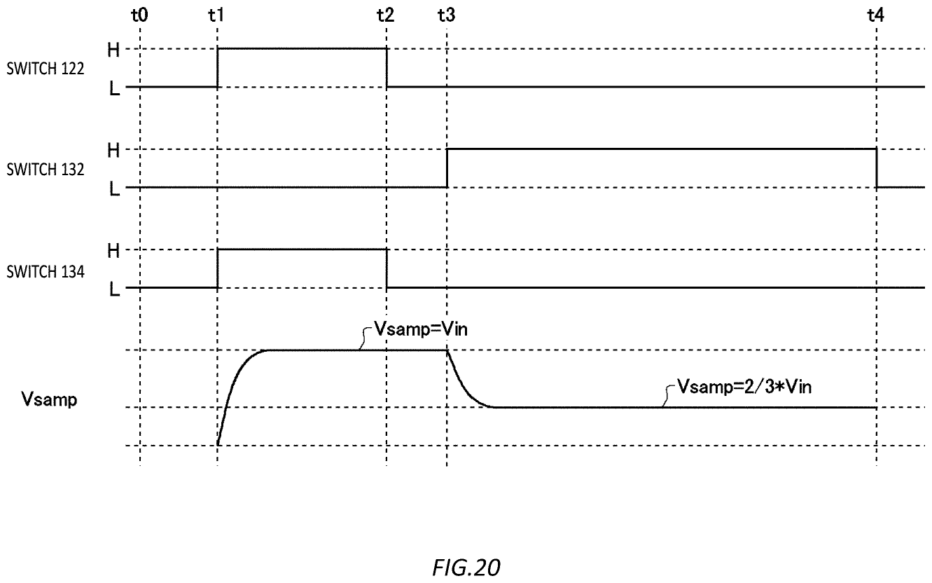

The operations of the sampling device 120 and the scaling device 130 in FIG. 19 will be described below with reference to FIG. 20. FIG. 20 is a timing diagram showing examples of operations of the sampling device 120 and the scaling device 130.

At a time t0, the switches 122, 132, and 134 are off. The figure shows that when each of the switches 122, 132, 134 is turned on, the voltage corresponding to the “H” level is applied, and when each of the switches 122, 132, 134 is turned off, the voltage corresponding to the “L” level is applied.

At a time t1, the load of the load device is set to L(n), and the voltage Vo indicates the voltage value Vin. According to this, the switch 122 is turned on, and the capacitor 124 is charged with the voltage Vin. In addition, the switch 134 is turned on, and the voltage of the capacitor 136 is discharged to be 0V (a ground voltage).

Next, at a time t2, the switch 122 is turned off and the switch 134 is turned off. In this manner, in the capacitor 124, the voltage value Vin which is the input voltage at the time t2 is sampled, and in the capacitor 136, 0V is sampled.

At a time t3, the switch 132 is turned on. In this manner, the voltage Vin sampled in the capacitor 124 is redistributed to the capacitors 124, 136, and the scaling device 130 outputs (2/3)×Vin as the voltage Vsamp. In this manner, the sampling and the scaling when K=2/3 are executed. After the processing of the sampling and the scaling ends, the switch 132 is turned off at a time t4.

By selecting a capacitance ratio of the capacitor 124 and the capacitor 136, it is possible to achieve the sampling and the scaling for different values of K satisfying K<1. The sampling device 120 and the scaling device 130 can also include a combination (not shown) of the capacitor and the switch, or a combination (not shown) of the switch and an operational amplifier, thereby making a configuration of K>1 possible.

While the present invention has been described by way of the embodiments, the technical scope of the present invention is not limited to the above-described embodiments. It is apparent to persons skilled in the art that various alterations or improvements can be made to the above-described embodiments. It is also apparent from the description of the claims that the embodiments to which such alterations or improvements are made can be included in the technical scope of the present invention.

The operations, procedures, steps, and stages of each process performed by a device, system, program, and method shown in the claims, specification, or drawings can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

10: power supply;
12: voltage source;
14: resistor;
16: constant current source;
18, 204: diode;
100, 300, 400: system;
110: load device;
112, 118: variable resistor;
114: variable current source;
116: variable power load;
118: variable resistor;
120, 180, 222: sampling device;
124, 136: capacitor;
130, 170, 190: scaling device;
122, 132, 134, 160, 202, 220: switch;
140, 224: comparator;
150: control device;
152: setting unit;
192: A/D converter;
194: first memory;
196: second memory;
198: determination unit;
200, 250: the DC-DC converter;
204: diode;
206: inductor;
210: switch control unit;
212: D/A converter;
214: detection device;
215: adder;
216: integrator;
218: pulse generator;
250: the DC-DC converter;
350: power storage device.

What is claimed is:

1. A control device that controls a load amount of a load device that receives supply of power which is output from a DC power supply, the control device comprising:
a setting unit that compares a voltage ratio in which a denominator is set to a first input voltage value indicating a magnitude of an input voltage which is applied to the load device when the load amount of the load device is set to a first load amount, and a numerator is set to a second input voltage value indicating a magnitude of an input voltage which is applied to the load device when the load amount of the load device is set to a second load amount obtained by multiplying the first load amount by a predetermined first coefficient, and a determination value in accordance with the first coefficient, and executes, based on a comparison result, a load amount setting process in which a load amount of the load device is set to a new first load amount which is larger or smaller than the first load amount, until a predetermined condition is satisfied.

2. The control device according to claim 1, wherein
in a case where the load amount setting process is repeated a predetermined number of times, the setting unit determines that the predetermined condition is satisfied, and ends the load amount setting process.

3. The control device according to claim 1, wherein
the setting unit sets a load amount of the load device to the new first load amount which is larger than the first load amount, in a case where the second load amount is larger than the first load amount, and the voltage ratio is larger than the determination value, and
the setting unit sets a load amount of the load device to the new first load amount which is smaller than the first load amount, in a case where the second load amount is larger than the first load amount, and the voltage ratio is smaller than the determination value.

4. The control device according to claim 1, wherein
the setting unit sets a load amount of the load device to the new first load amount which is larger than the first load amount, in a case where the second load amount is smaller than the first load amount, and the voltage ratio is smaller than the determination value, and
the setting unit sets a load amount of the load device to the new first load amount which is smaller than the first load amount, in a case where the second load amount is smaller than the first load amount, and the voltage ratio is larger than the determination value.

5. The control device according to claim 1, wherein
the setting unit compares a first value obtained by multiplying the first input voltage value by a predetermined second coefficient, and a second value obtained by multiplying the second input voltage value by a predetermined third coefficient, and the determination value is a ratio of the second coefficient and the third coefficient.

6. The control device according to claim 5, wherein
the first value is a value obtained by multiplying the first input voltage value by the second coefficient in accordance with the first coefficient, and the second value is the second input voltage value.

7. The control device according to claim 6, wherein
in a case where the first coefficient is α, the second coefficient is K, the first input voltage value is Vin, and the second input voltage value is Vin′,
if (Vin′−K×Vin)×(α−1)>0, the setting unit sets the load amount of the load device to the new first load amount which is larger than the first load amount, and
if not (Vin′−K×Vin)×(α−1)>0, the setting unit sets the load amount of the load device to the new first load amount which is smaller than the first load amount.

8. The control device according to claim 5, wherein
the first value is the first input voltage value, and the second value is a value obtained by multiplying the second input voltage value by the third coefficient in accordance with the first coefficient.

9. The control device according to claim 8, wherein
in a case where the first coefficient is α, the third coefficient is 1/K, the first input voltage value is Vin, and the second input voltage value is Vin′,
if (1/K×Vin′−Vin)×(α−1)>0, the setting unit sets the load amount of the load device to the new first load amount which is larger than the first load amount, and
if not (1/K×Vin′−Vin)×(α−1)>0, the setting unit sets the load amount of the load device to the new first load amount which is smaller than the first load amount.

10. The control device according to claim 7, wherein
the load amount of the load device is able to be changed by changing an input current value indicating a magnitude of a current which is input to the load device, and
K is 2−α.

11. The control device according to claim 7, wherein
the load amount of the load device is able to be changed by changing a resistance value indicating a magnitude of a resistance that consumes power at the load device, and
K is 2/(α+1).

12. The control device according to claim 7, wherein
a value of power consumption of the load device is able to be changed, and
K is lower than or equal to 1+√(1−α).

13. The control device according to claim 1, wherein
the DC power supply is a solar cell.

14. The control device according to claim 1,
wherein the load device is a voltage conversion device that steps up or steps down a DC voltage from the DC power supply and supplies the stepped up or stepped down DC voltage to a power storage device.

15. The control device according to claim 14,
wherein the voltage conversion device includes an inductor through which a direct current from the DC power supply flows, a switch which is turned on or turned off to control the direct current flowing through the inductor, and a switch control unit which performs an on and off control of the switch such that a current of a target input current value corresponding to the load amount set by the setting unit, is input from the DC power supply.

16. A system comprising:
the control device according to claim 1; and
a voltage conversion device that includes an inductor through which a direct current from the DC power supply flows, a switch which is turned on or turned off to control the direct current flowing through the inductor, and a switch control unit which performs an on and off control of the switch such that a current of a target input current value corresponding to the load amount set by the setting unit, is input from the DC power supply, and steps up or steps down a DC voltage from the DC power supply and supplies the stepped up or stepped down DC voltage to a power storage device, wherein
the switch control unit executes the on and off control of the switch in a case where an input voltage value indicating a magnitude of an input voltage which is applied from the DC power supply to the voltage conversion device is higher than or equal to a reference voltage value which is an input voltage value indicating a magnitude of an input voltage which is applied to the load device after the setting unit executes the load amount setting process until the predetermined condition is satisfied, and does not execute the on and off control of the switch in a case where the input voltage value indicating the magnitude of the input voltage which is applied from the DC power supply to the voltage conversion device is smaller than the reference voltage value.

17. The system according to claim 16, comprising:
a first switch that is turned on or turned off for input of the direct current from the DC power supply to the load device; and
a second switch that is turned on or turned off for input of the direct current from the DC power supply to the voltage conversion device, wherein
in a state in which the first switch is turned on and the second switch is turned off, the setting unit executes the load amount setting process until the predetermined condition is satisfied, and
in a state in which the first switch is turned on and the second switch is turned off, the reference voltage value is acquired, and then in a state in which the first switch is turned off and the second switch is turned on, the switch control unit repeats, for a predetermined period, conditional processing in which the switch control unit executes the on and off control of the switch in a case where the input voltage value indicating the magnitude of the input voltage which is applied from the DC power supply to the voltage conversion device is higher than or equal to the reference voltage value, and the switch control unit does not execute the on and off control of the switch in a case where the input voltage value indicating the magnitude of the input voltage which is applied from the DC power supply to the voltage conversion device is smaller than the reference voltage value.

18. A control method for controlling a load amount of a load device that receives supply of power which is output from a DC power supply, the control method comprising:
setting of executing a load amount setting process until a predetermined condition is satisfied, wherein the load amount setting process comprises:
setting the load amount of the load device to a first load amount, acquiring a first input voltage value indicating a magnitude of an input voltage which is applied to the load device when the load amount of the load device is set to the first load amount, setting the load amount of the load device to a second load amount obtained by multiplying the first load amount by a predetermined first coefficient, acquiring a second input voltage value indicating a magnitude of an input voltage which is applied to the load device when the load amount of the load device is set to the second load amount, comparing a voltage ratio in which a denominator is set to the first input voltage value and a numerator is set to the second input voltage value, and a determination value in accordance with the first coefficient, and setting, based on a comparison result, the load amount of the load device to a new first load amount which is larger or smaller than the first load amount.

19. The control method according to claim 18, wherein
the setting includes executing the load amount setting process until the predetermined condition is satisfied, in a state in which a first switch is turned on, and a second switch is turned off, the first switch being turned on or turned off for input of a direct current from the DC power supply to the load device, the second switch being turned on or turned off for input of the direct current from the DC power supply to a voltage conversion device that steps up or steps down a DC voltage from the DC power supply and supplies the stepped up or stepped down DC voltage to a power storage device,
the control method further comprising:
acquiring, as a reference voltage value, an input voltage value indicating a magnitude of an input voltage which is applied to the load device, in the state in which the first switch is turned on, and the second switch is turned off, after the executing of the load amount setting process until the predetermined condition is satisfied; and
repeating, for a predetermined period, in a state in which the reference voltage value is acquired, and then the first switch is turned off and the second switch is turned on, conditional processing in which an on and off control of a switch included in the voltage conversion device is executed in a case where an input voltage value indicating a magnitude of an input voltage which is applied from the DC power supply to the voltage conversion device, is higher than or equal to the reference voltage value, and the on and off control of the switch included in the voltage conversion device is not executed in a case where the input voltage value indicating the magnitude of the input voltage which is applied from the DC power supply to the voltage conversion device, is smaller than the reference voltage value.

20. The control method according to claim 18, wherein
the setting includes
setting the load amount of the load device to the new first load amount which is larger than the first load amount, in a case where the second load amount is larger than the first load amount, and the voltage ratio is larger than the determination value, and
setting the load amount of the load device to the new first load amount which is smaller than the first load amount, in a case where the second load amount is larger than the first load amount, and the voltage ratio is smaller than the determination value, or
the setting includes
setting the load amount of the load device to the new first load amount which is larger than the first load amount, in a case where the second load amount is smaller than the first load amount, and the voltage ratio is smaller than the determination value, and
setting the load amount of the load device to the new first load amount which is smaller than the first load amount, in a case where the second load amount is smaller than the first load amount, and the voltage ratio is larger than the determination value.

21. The control device according to claim 9, wherein
the load amount of the load device is able to be changed by changing an input current value indicating a magnitude of a current which is input to the load device, and
K is 2−α.

22. The control device according to claim 9, wherein
the load amount of the load device is able to be changed by changing a resistance value indicating a magnitude of a resistance that consumes power at the load device, and
K is 2/(α+1).

23. The control device according to claim 9, wherein
a value of power consumption of the load device is able to be changed, and
K is lower than or equal to 1+√(1−α).
